(19) United States
(12) Patent Application Publication
(10) Pub. No.: US 2012/0015825 A1
(43) Pub. Date: Jan. 19, 2012

(54) ANALYTICAL SYSTEMS AND METHODS WITH SOFTWARE MASK

(75) Inventors: Cheng Frank Zhong, Fremont, CA (US); Austin B. Tomaney, Burlingame, CA (US); Patrick Marks, San Francisco, CA (US); Stuart George Johnson, Belmont, CA (US); James N. LaBrenz, San Francisco, CA (US); Paul Lundquist, San Francisco, CA (US)

(73) Assignee: Pacific Biosciences of California, Inc., Menlo Park, CA (US)

(21) Appl. No.: 13/174,089

(22) Filed: Jun. 30, 2011

Related U.S. Application Data
(60) Provisional application No. 61/361,853, filed on Jul. 6, 2010.

(51) Int. Cl. C40B 30/10; C40B 20/08; C40B 40/00; C40B 30/04

(52) U.S. Cl. 506/6; 506/12; 506/9; 506/13

(57) ABSTRACT

Methods and systems for obtaining and processing optical signal data from analytical reactions, and in processing signal data from arrays of sequence-by-incorporation processes to identify nucleotide sequences of template nucleic acids and larger nucleic acid molecules, e.g., genomes or fragments thereof are described. Defining and applying a 2-dimensional software mask allows for obtaining signal data from arrays with higher signal to noise than where the mask is not applied.

### CROSS REFERENCE TO RELATED APPLICATIONS

This application claims priority and benefit of Provisional Patent Application 61/361,853 filed on Jul. 6, 2010, the full disclosure of which is incorporated by reference herein in its entirety.

### STATEMENT REGARDING FEDERALLY SPONSORED RESEARCH

Portions of the invention were made with government support under NHGRI Grant No. 5R01-HG003710-03 and the government may have certain rights to the invention.

### BACKGROUND OF THE INVENTION

Optical detection systems are generally employed in a wide variety of different analytical operations. For example, simple multi-well plate readers have been ubiquitously employed in analyzing optical signals from fluid based reactions that were being carried out in the various wells of a multiwell plate. These readers generally monitor the fluorescence, luminescence or chromogenic response of the reaction solution that results from a given reaction in each of 96, 384 or 1536 different wells of the multiwell plate.

Other optical detection systems have been developed and widely used in the analysis of analytes in other configurations, such as in flowing systems, i.e., in the capillary electrophoretic separation of molecular species. Typically, these systems have included a fluorescence detection system that directs an excitation light source, e.g., a laser or laser diode, at the capillary, and is capable of detecting when a fluorescent or fluorescently labeled analyte flows past the detection region (see, e.g., ABI 3700 Sequencing systems, Agilent 2100 Bioanalyzer and ALP systems, etc.).

Still other detection systems direct a scanning laser at surface bound analytes to determine where, on the surface, the analytes have bound. Such systems are widely used in molecular array based systems, where the positional binding of a given fluorescently labeled molecule on an array indicates a characteristic of that molecule, e.g., complementarity or binding affinity to a given molecule (See, e.g., U.S. Pat. No. 5,578,832).

Notwithstanding the availability of a variety of different types of optical detection systems, the development of real-time, highly multiplexed, single molecule analyses has given rise to a need for detection systems that are capable of detecting large numbers of different events, at relatively high speed, and that are capable of deconvolving potentially complex, multi-wavelength signals. Further, such systems generally require enhanced sensitivity and as a result, increased signal-to-noise ratios with lower power requirements. The present invention meets these and a variety of other needs. Analysis of the subtleties of the voluminous amounts of genetic information will continue to have profound effects on the personalization of medicine. For example, this advanced genetic knowledge of patients has and will continue to have broad impact on the ability to diagnose diseases, identify predispositions to diseases or other genetically impacted disorders, the ability to identify reactivity to given drugs or other treatments, whether adverse or beneficial.

Various embodiments and components of the present invention employ pulse, signal, and data analysis techniques that are familiar in a number of technical fields. For clarity of description, details of known techniques are not provided herein. These techniques are discussed in a number of available references works, such as: R. B. Ash. Real Analysis and Probability. Academic Press, New York, 1972; D. T. Bertsekas and J. N. Tsitsiklis. Introduction to Probability. 2002; K. L. Chung. Markov Chains with Stationary Transition Probabilities, 1967; W. B. Davenport and W. L Root. An Introduction to the Theory of Random Signals and Noise. McGraw-Hill, New York, 1958; S. M. Kay, Fundamentals of Statistical Processing, Vols. 1-2, (Hardcover—1998); Monsoon H. Hayes, Statistical Digital Signal Processing and Modeling, 1996; Introduction to Statistical Signal Processing by R. M. Gray and L. D. Davisson; Modern Spectral Estimation: Theory and Application/Book and Disk (Prentice-Hall Signal Processing Series) by Steven M. Kay (Hardcover—January 1988); Modern Spectral Estimation: Theory and Application by Steven M. Kay (Paperback—March 1999); Spectral Analysis and Filter Theory in Applied Geophysics by Burkhard Buttkus (Hardcover—May 11, 2000); Spectral Analysis for Physical Applications by Donald B. Percival and Andrew T. Walden (Paperback—Jun. 25, 1993); Astronomical Image and Data Analysis (Astronomy and Astrophysics Library) by J.-L. Starck and F. Murtagh (Hardcover—Sep. 25, 2006); Spectral Techniques In Proteomics by Daniel S. Sem (Hardcover—Mar. 30, 2007); Exploration and Analysis of DNA Microarray and Protein Array Data (Wiley Series in Probability and Statistics) by Dhammika Amaratunga and Javier Cabrera (Hardcover—Oct. 21, 2003), Horne, Astronomical Society of the Pacific, 98, 609-617, 1986.

### BRIEF SUMMARY OF THE INVENTION

The invention is generally directed to processes, and particularly computer implemented processes for analyzing fluorescent signals from sequence by incorporation systems, and for ultimately identifying sequence information of a target nucleic acid sequence. Consequently, the invention is also directed to systems that carry out these processes.

In one aspect the invention comprises a method for measuring the optical emission from an array of sources from an analytical reaction comprising: providing an array comprising a transparent substrate having an opaque cladding layer on its top surface having an array of nanoscale apertures extending through the cladding layer to the top surface of the transparent substrate; contacting the array with an analytical sample comprising one or more fluorescent labels; positioning the array within an optical system of an analytical instrument; illuminating the array from below with a excitation light such that fluorescent light emitted from each of the apertures is imaged within a region of X by Y pixels on each of D detectors; measuring the relative intensity at each of the pixels on each of the regions of X by Y pixels at each of the D detectors; using the relative intensities detected at each of the X by Y pixels to define a software mask having a weighting factor for each of the X by Y pixels; sending signals from the D detectors to a computer for processing the signals; and using the software mask to treat signals sent from the D detectors, thereby improving the signal to noise of the measured emitted fluorescent light from the apertures over the signal to noise without the software mask.

In some embodiments the software mask is defined by determining a centroid for each feature and determining a point spread function (PSF) for each feature. In some embodiments the software mask is defined by determining a centroid for each feature and applying a pre-determined point spread function (PSF) for each feature. In some embodiments the weighting factor for each of the pixels includes a noise component. In some embodiments the weighting factor comprises an inverse variance value for each pixel. In some embodiments the inverse variance value for each pixel is determined during the analytical reaction.

In some embodiments the fluorescent light used to define the software mask comprises background fluorescence. In some embodiments the fluorescent light used to define the software mask comprises signals corresponding to the analytical reaction. In some embodiments the fluorescent light used to define the software mask comprises signals corresponding to the analytical reaction and background fluorescence. In some embodiments the array comprises between 10,000 and 5 million nanoscale apertures. In some embodiments the D is 1, 2, 3, 4, 5, or 6. In some embodiments wherein D is 4.

In some embodiments the light imaged on each of the D detectors represents a different portion of the optical spectrum. In some embodiments the analytical sample comprises D fluorescent labels, and the light imaged on each of the D detectors represents a portion of the spectrum corresponding to one of the D fluorescent labels. In some embodiments the analytical reaction comprises the measurement of binding or association. In some embodiments one member of a binding pair is immobilized within the apertures, another member of the binding pair is in solution, and the emitted light is used to measure the binding or association.

In some embodiments FRET and/or fluorescence quenching is used to measure the binding or association. In some embodiments the region of X by Y pixels comprises from about 9 pixels to about 100 pixels. In some embodiments the software mask is defined during the analytical reaction. In some embodiments the analytical reaction comprises a single-molecule reaction. In some embodiments the analytical reaction comprises nucleic acid sequencing. In some embodiments step of contacting the array with the analytical sample is performed after positioning the array in the optical system. In some embodiments the step of contacting the array with the analytical sample is performed prior to positioning the array in the optical system.

In some embodiments a weighted sum method is used to determine the pixel weightings of the software mask. In some embodiments the software mask is comprised of a centroid corresponding to each aperture and a set of weights derived from a PSF describing the relative pixel weighting relative to the centroid for that aperture. In some embodiments a PSF for each of the apertures is measured during the measuring step. In some embodiments a PSF for each of the apertures is determined prior to the measuring step.

In one aspect the invention comprises a sequencing method comprising: providing an array comprising a transparent substrate having an opaque cladding layer on its top surface having an array of nanoscale apertures extending through the cladding layer to the top surface of the transparent substrate; contacting the array with a sequencing reaction mixture comprising D fluorescently labeled nucleotide analogs and a polymerase complex comprising a polymerase, a primer and a template nucleic acid; positioning the array within an optical system of an analytical instrument; initiating the sequencing reaction; illuminating the array from below with a excitation light such that fluorescent light emitted from each of the apertures is imaged onto a region of X by Y pixels on each of D detectors; measuring the relative intensity at each of the X by Y pixels while the sequencing reaction is occurring; using the relative intensities detected at each of the X by Y pixels to define a software mask having a weighting factor for each of the pixels; sending signals from the D detectors to a computer for processing the signals; using the software mask to treat signals coming from the D detectors, thereby improving the signal to noise of the measured emitted fluorescent light from the apertures over when the software mask is not used.

In some embodiments the software mask is defined by determining a centroid for each feature and determining a point spread function (PSF) for each feature. In some embodiments the software mask is defined by determining a centroid for each feature and applying a pre-determined point spread function (PSF) for each feature. In some embodiments the weighting factor for each of the pixels includes a noise component. In some embodiments the weighting factor comprises an inverse variance value for each pixel. In some embodiments the inverse variance value for each pixel is determined during the sequencing reaction. In some embodiments the fluorescent light used to define the software mask comprises background fluorescence. In some embodiments the fluorescent light used to define the software mask comprises signals corresponding to the sequencing reaction.

In some embodiments the fluorescent light used to define the software mask comprises background fluorescence. In some embodiments the fluorescent light used to define the software mask comprises signals corresponding to the sequencing reaction and background fluorescence. In some embodiments D is 4.

In some embodiments the region of X by Y pixels comprises from about 9 to about 100 pixels. In some embodiments the software mask is defined after initiating the sequencing reaction. In some embodiments the software mask is defined prior to initiating the sequencing reaction. In some embodiments the polymerase is immobilized within the aperture, and the emitted fluorescent signals from the sequencing reaction correspond to the association of the nucleotide analogs with the polymerase enzyme. In some embodiments the emitted signals from the sequencing reaction comprise signals from FRET or quenching.

In some embodiments n a weighted sum method is used to determine the pixel weightings of the software mask. In some embodiments the software mask is comprised of a centroid corresponding to each aperture and a set of weights determined from a PSF describing the relative pixel weighting relative to the centroid for that aperture. In some embodiments a PSF for each of the apertures is measured during the measuring step. In some embodiments a PSF for each of the apertures is determined prior to the measuring step.

In one aspect the invention comprises a method for measuring the optical emission from an array of sources from an analytical reaction comprising: providing an array comprising a transparent substrate having an opaque cladding layer on its top surface having an array of nanoscale apertures extending through the cladding layer to the top surface of the transparent substrate; positioning the array within an optical system of an analytical instrument; illuminating the array in transmission mode by passing light through the apertures from the top; imaging the transmitted light through each of the apertures onto a region of X by Y pixels on each of D detectors; measuring the relative intensity at each of the X by Y pixels; using the relative intensities detected at each of the X by Y pixels to define a software mask having a weighting factor for each of the pixels; performing an analytical reaction in at least some of the nanoscale apertures; illuminating the array from below with a excitation light such that fluorescent light is emitted from the apertures, detected at the detectors, and used to characterize the analytical reaction; and using the software mask to treat signals from the detector to improve the signal to noise of the measured emitted fluorescent light at each of the D detectors over that without the software mask. In some embodiments D is 1, 2, 3, 4, 5, or 6. In some embodiments D is 4.

In some embodiments the light imaged on each of the D detectors represents a different portion of the optical spectrum. In some embodiments a weighted sum method is used to determine the pixel weightings of the software mask. In some embodiments the software mask is comprised of a centroid corresponding to each aperture and a set of weights determined from a PSF describing the relative pixel weighting relative to the centroid for that aperture.

In one aspect the invention comprises a method of concurrently measuring D spectrally different fluorescent emission signals in an analytical instrument where D is greater than 1 comprising: i. providing a first array comprising a transparent substrate having an opaque cladding layer on its top surface having an array of nanoscale apertures extending through the cladding layer to the top surface of the transparent substrate; ii. contacting a first array with a liquid sample comprising a one of D fluorescent labels; iii. positioning the array within an optical system of an analytical instrument; iv. illuminating the array from below with a excitation light such that fluorescent light emitted from each of the apertures is imaged within a region of X by Y pixels on each of D detectors, wherein each of the D detectors has a different spectral sensitivity, each representing a spectral channel; v. repeating steps ii-iv for each of D fluorescent labels, thereby obtaining the relative intensity for each of the D dyes on each region of X by Y pixels on each of D detectors; vi. using the relative intensity data to produce a matrix of relative intensities for each region of X by Y pixels on each of the D detectors. vii. positioning a second array within the optical system; viii. contacting the second array with an analytical sample comprising each of the D fluorescent labels; ix. illuminating the second array from below with a excitation light such that fluorescent light emitted from the analytical sample from at least some of the apertures is imaged onto the regions of X by Y pixels on the D detectors; and x. using the matrix produced in step vi to identify one or more of the D fluorescent labels in the analytical sample, thereby providing information about the analytical sample. In some embodiments D is 2, 3, 4, 5, or 6. In some embodiments D is 4.

In some embodiments the region of X by Y is from about 9 to about 100 pixels. In some embodiments the analytical reaction comprises the measurement of binding or association. In some embodiments one member of a binding pair is immobilized within the apertures, another member of the binding pair is in solution, and the emitted light is used to measure the binding or association. In some embodiments the analytical reaction comprises a single-molecule reaction. In some embodiments analytical reaction comprises nucleic acid sequencing.

In one aspect the invention comprises an instrument for single-nucleic acid sequencing comprising: an optical system comprising D detectors, each detector sensitive to a different portion of the light spectrum each representing a spectral channel; an array positioned in the optical system comprising a transparent substrate having an opaque cladding layer on its top surface having an array of nanoscale apertures extending through the cladding layer to the top surface of the transparent substrate; a sequencing reaction mixture in contact with the array comprising D fluorescently labeled analogs and a polymerase complex comprising a polymerase, a primer and a template nucleic acid; an illumination system configured to illuminate the array from above with transmission light and from below with a excitation light such that either transmitted light or fluorescent emitted light from each of the apertures can be imaged within a region of X by Y pixels on each of the D detectors; a computer system configured to use the relative intensities detected at each of the X by Y pixels to define a software mask having a weighting factor for each of the pixels; and configured to use the software mask to treat signals coming from the D detectors to improve the signal to noise of the measured emitted fluorescent light at each of the D detectors. In some embodiments D is 4.

In some embodiments the region of X by Y pixels comprise from about 9 to about 100 pixels. In some embodiments the array comprises between 10,000 and 5 million nanoscale apertures. In some embodiments the instrument comprises detection optics comprising three dichroic elements for separating the emitted light into D spectral channels, each directed to a different detector. In some embodiments the illumination system comprises two lasers.

In some embodiments the illumination system comprises a diffractive optical element for splitting an illumination beam into an array of beamlets whereby each aperture on the array is illuminated by a beamlet. In some embodiments one laser is provided to excite two of the four fluorescently labeled analogs, and the other laser is provided to excite the other two. In some embodiments the detectors comprise CMOS detectors. In some embodiments the transmission light is used to obtain a transmission image of the array for mapping the images of the apertures on the array onto the detectors prior to sequencing. In some embodiments the apertures comprise zero mode waveguides.

The invention and various specific aspects and embodiments will be better understood with reference to the following drawings and detailed descriptions. In some of the drawings and detailed descriptions below, the present invention is described in terms of the important independent embodiment of a system operating on a logic processing device, such as a computer system. This should not be taken to limit the invention, which, using the teachings provided herein, can be applied to any number of logic processors working together, whether incorporated into a camera, a detector, other optical components, or other information enabled devices or logic components incorporated into laboratory or diagnostic equipment or in functional communication therewith. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention that are implemented on a computer or other logic processing systems or circuits, as will be understood from the teachings herein, may be implemented or accomplished using any appropriate implementation environment or programming language, such as C, C++, Cobol, Pascal, Java, Java-script, HTML, XML, dHTML, assembly or machine code programming, RTL, etc. All references, publications, patents, and patent applications cited herein are hereby incorporated by reference in their entirety for all purposes.

### BRIEF DESCRIPTION OF THE DRAWINGS

FIG. 1 is a flow chart illustrating the processing of signal data.

FIG. 2 shows a plot of intensity across a number of pixels on a detector illustrating a PSF having a Gaussian profile.

FIG. 3 illustrates the process of determining a PSF in order to produce a 2 dimensional software mask. In FIG. 3(A), the PSF for the signal source is circularly symmetrical and centered within the X by Y region of pixels, in FIG. 3(B) the PSF is not circularly symmetrical.

FIG. 4(A) shows emission intensity versus wavelength plots for four different dyes, and shows the four different channels corresponding to the four labels. The signal from each of the four channels is sent to each of four detectors. FIG. 4(A) shows a spectral matrix determined by measuring the relative intensity at each detector for each label.

FIG. 5 provides a schematic illustration of an overall system used for monitoring analysis reactions such ad for sequencing by incorporation analyses

FIG. 6 shows an example of an overall sequence process comprised of three general process categories.

FIG. 7 provides a flow chart illustrating an overall sequencing process.

FIG. 8 is a flow chart illustrating a pulse recognition process for a sequencing method of the invention.

FIG. 9 is a graphic illustration of the analysis of sequencing-by-incorporation-reactions on an array of reaction locations according to specific embodiments of the invention.

FIG. 10 shows a region of pixels on one of four detectors onto which images of a number ZMWs in an array of ZMWs are imaged.

### DETAILED DESCRIPTION OF THE INVENTION

### I. Overview

In general, the present invention is directed to automated processes, and machine readable software that instructs such processes, for obtaining and deciphering signal data obtained from a detection system that is optically coupled to any of the foregoing reactions, and particularly where such processes identify the incorporation of a nucleotide or nucleotide analog in a template dependent fashion, and identify the label associated with the incorporated analog and by extension, the analog and its complementary base in the template sequence.

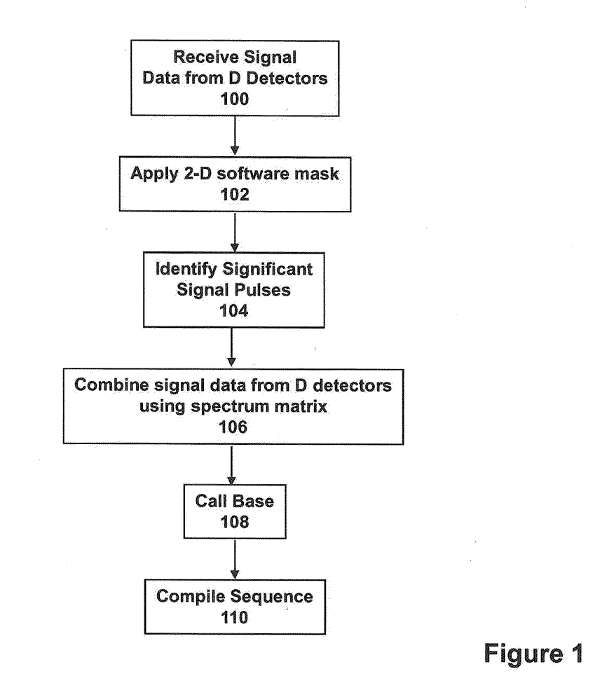

A general flow chart illustrating the processing of signal data is provided in FIG. 1. In some cases, the orders of the steps can be altered from the order shown. In general, signal data is received by the processor at step 100. The systems of the present invention utilize D detectors where D is more than one. Each of the detectors is measuring a different aspect of the reactions occurring on the substrate array. Typically, each of the D detectors is sent light from a different portion of the optical spectrum. For example, the emitted light can be separated using optical components such as filters and dichroics into D different channels, and the light from each of the channels is sent to a different detector. Each of the D channels can be selected to correspond to a different label within the sample, whereby each of the D detectors measures the image from a different label. This configuration allows for the signal from each of the D labels to monitored concurrently in real time at each of the features on the substrate array.

For nucleic acid sequencing, a D of four can be used, wherein four labels, one for each of the nucleotide bases in DNA or RNA is used to identify the presence of that nucleotide or nucleotide analog. Four optical channels can then be used to direct light to each of four detectors. Each of the four detectors is thereby primarily used to detect the presence of one of the four bases. As will be described in greater detail below, the signal from one label can extend from its channel into other optical channels, so there may be signal in one detector, for example, from a label in a neighboring channel. Methods of correlating the signal from one detector with the signal from a single nucleotide label by applying a spectral matrix is described below.

While some preferred embodiments of the invention are directed to nucleic acid sequencing and use a D of four, it is understood that D can be any suitable number greater than 1. For example, D can be 2, 3, 4, 5, or 6. In some cases, D can be 7, 8, 9 or greater. Where each detector monitors a portion of the spectrum corresponding to a specific label, because of the spectral width of labels, especially fluorescent organic dyes, and the limited span of the useful light spectrum, it can be difficult to extend D too high. However, labels with sharp emission peaks such as lanthanides or quantum dots, it is possible to separate larger numbers of signals, allowing for higher values for D.

Each of the D detectors comprises an array of pixels, each pixel capable of independently measuring the intensity of the light directed toward it. In order to identify and quantify the signal from each of the D labels, at each of the detectors, we have found that the signal to noise of the measurement can be improved significantly by applying a 2-dimensional software mask to the data from the detectors. The software mask is a pixel weighting map that is developed in order to maximize the SNR of the extracted signal intensity. The software mask is a weighted sum filter approach that applies a 2-dimensional multiplier digital filter in data processing. The software mask not only selects the pixels that are to be given used for analysis, it provides a weighting factor for each pixel such that the appropriate relative contribution of that pixel is used. As will be described in more detail, the software mask can include not only an estimate of the expected signal, but also includes an estimate of noise using an appropriate noise model. The use of a software mask is particularly important for analytical systems in which a relatively small amount of light is released, such as for single molecule reactions.

The analytical arrays of the invention generally have a regular pattern of features such as wells, apertures, or ZMWs. Within each of these features an analytical reaction may occur in which the presence, absence, or amount of D different labels can be determined by the level of light emission from the feature. This results in an array of bright features imaged onto the detectors on an otherwise dark background. The first step of producing the software mask generally involves a gridding procedure in which each of the features on the array is imaged onto a set of pixels on each of the D detectors. Gridding allows for each feature on the array to be mapped to a specific X by Y region on each of the D detectors. For example, a centroid can be determined for a given feature on a detector. This centroid can be placed within an X by Y region of pixels. Subsequently, during an analytical reaction, light that falls within this region will be identified as emanating from that feature. Thus, gridding can be used to correlate measured signals with events occurring within specific features. We have found that in low light situations, however gridding alone can result in a signal with lower than desirable signal to noise. This is because not all of the pixels within the X by Y region provide the most relevant signal data, with some pixels receiving relatively little light from the signal source, and therefore relatively more background noise. Thus, that by including pixels assigned to the feature that are unlikely to receive much light from the feature, that the signal to noise of the measurement can be undesirably low. We have found that by providing a relative weight to each of the pixels within the X by Y region, the signal to noise of the measurements can be significantly improved.

A particularly preferred method of providing the appropriate weights to each of the X by Y pixels involves determining a point spread function (PSF) to the 2-dimensional region of pixels in order calculate optimal weights with which to sum the pixels relevant to the feature signal being measure. The term PSF is used herein to refer to a measured or calculated 2-dimensional intensity profile. The PSF is used to determine the weights to be assigned to pixies within the X by Y region. In some cases, the measured PSF is applied directly to the pixels, but generally the PSF information is combined with other information, such as an estimate of the noise in order to determine the pixel weighting. In some cases, we refer to applying a PSF. It is to be understood that this means that information from the PSF determination is applied in the form of weights to the pixels. In some cases, the measured PSF in an X by Y region will not correspond directly to the PSF that is applied to that X by Y region. The PSF to be applied to a given X by Y region on one of the D detectors can be determined in a number of ways. In some cases, the PSF is measured experimentally, in some cases the PSF is determined theoretically, and in some cases experiment and theoretical calculations are combined to produce the PSF.

In some cases, a PSF determination can be used to define, for example, a region of interest or (ROI) such as a circle having a specified diameter extending across multiple pixels in the X by Y region, that is, providing a flat profile. The pixels that are completely within the circle would be given a relative weighting of 1. The pixels that are partially covered will receive a weighting that represents the fraction of the pixel which is covered by the circular profile. Pixels that are outside of the circle completely would be given a relative weighting of 0. Thus, when the signal from all of the pixels in the X by Y region are combined to represent the measured intensity from one signal source on the array, the relative intensity from each signal is multiplied by the weighting factor for that pixel. In this way, the signal measured by pixels completely inside the circle are given maximum weight, signal from pixels outside of the circle, which would be expected to have little or no actual illumination from the image of the signal source are given no weight, and signal from those pixels partly covered are given partial weight. Where a flat profile is used, the shape of the flat profile can be any suitable shape, which can be determined experimentally alone, or can be combined with theoretical models. The shape can be, for example, a circle, an ellipse, a star, a polygon, or any other arbitrary shape. The flat profile determined using information from the PSF can be centered with respect to the centroid of the image, or can be offset from the centroid in order to provide the best estimate of where emitted signal from the signal source will impinge on the detector. The shape may correspond to that of the signal source, or may be a completely different shape that is formed by passing through the collection optical system. The shape and size of the applied profile can be the same for each feature on all X by Y regions of all D detectors, or the shape and size can be varied. In some cases, for example, the magnification across the field view may be different, such that different size profiles are applied in different portions of the detector. In some cases, since each of the D detectors is generally measuring signal from a different set of wavelengths than the other detectors, differences in wavelength can result in different shapes and or sizes of applied profiles as determined by measuring the PSF on each of the detectors.

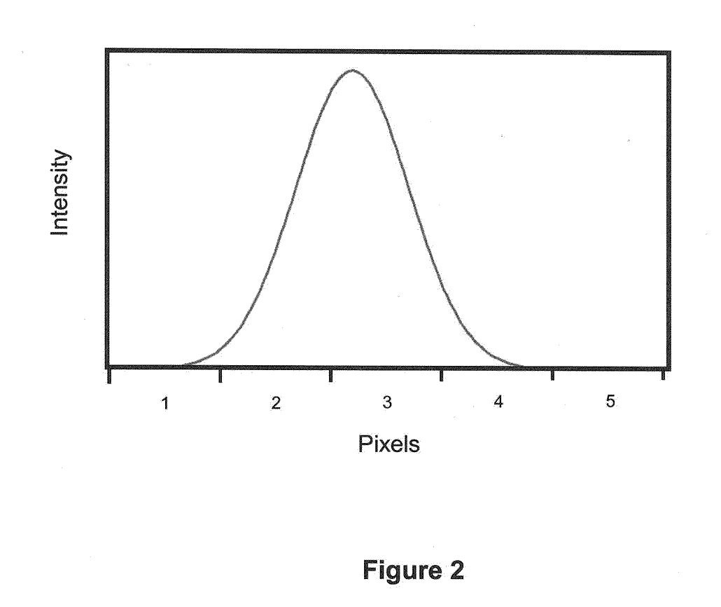

Knowledge of the expected PSF within the feature ROI allows for optimal pixel weighting. FIG. 2 shows a PSF that was determined for a signal on a detector by fitting of experimental measurements. The plot shows the relative intensity plotted across one dimension of an A by Y array of pixels. For this PSF, the profile is expected to be circularly symmetrical on the detector. The centroid of the image is within pixel 3, but not exactly at its center. As described in more detail below, the centroid for the PSFs can be determined at a sub-pixel level. The PSF does not extend to pixel 5, which would therefore be given a weighting of 0. Pixel 1, however, has some expected light intensity from the PSF, and would be provided a small, but non-zero value. The PSF profile in FIG. 2 is approximately Gaussian. The PSF can have any suitable profile, either experimentally determined or otherwise established. In some cases, for example, the profile can be asymmetrical. In some cases the PSF can have a central region with lower or no intensity, providing e.g. a donut shaped profile. As with flat PSFs, the shape and size of the gradient PSF can be the same for each feature on all X by Y regions of all D detectors, or the shape and size can be varied. In some cases, for example, the magnification across the field view may be different, such that different size PSFs are applied in different portions of the detector. In some cases, since each of the D detectors is generally measuring signal from a different set of wavelengths than the other detectors, differences in wavelength can result in different shapes, sizes, or gradients of the expected PSF on each of the detectors.

In some cases, the PSF for each aperture at each of the D detectors is determined experimentally. This can be particularly useful where the local structure of the signal source and the optical train can result in different PSF profiles for different signal sources in the array. This method can require more computational power and complexity than the methods described above, but can also provide improved data quality by optimizing the detected signal from each source. Such corrections for local structure can be useful, for example, when the array of signal sources comprise integral arrays of micromirrors as described for example in U.S. Patent Application 2010/0099100 which is incorporated herein in its entirety by reference for all purposes. The PSFs for each signal source onto each corresponding X by Y region in each detector can be determined either using a calibration array or on the same array used for analysis. An advantage of using a calibration array is that the PSF determination can be made once and used many times for subsequent arrays. An advantage of the using the same array that is used for analysis is that if there are unique features that vary from array to array, these will be captured in the measured PSFs resulting in higher quality, higher signal to noise data. The PSFs can be determined in trans-illumination mode, or using optical signals from the signal sources on the array. The optical signal sources can be any suitable source of photons, for example light from chemi-luminescence, phosphorescence, fluorescence, or scattering. While the methods of the invention are described with respect to light, the methods of the invention can also be used for other sources of electromagnetic radiation. For example, the methods of the invention could be applied where suitable to X-rays, ultraviolet radiation, microwaves or radio waves.

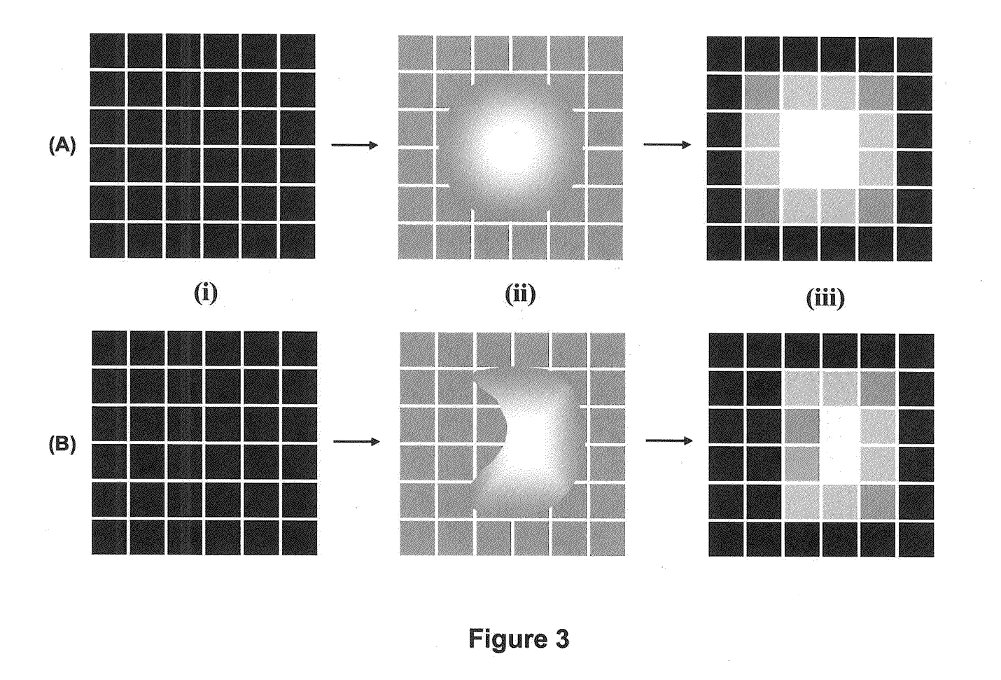

An example of determining a PSF, and using the PSF to provide a set of weights to an X by Y region of a detector is shown in FIG. 3. FIG. 3A illustrates the determination of a PSF to a 6 by 6 region of pixels on a detector. Onto the 6 by 6 array of pixels shown in FIG. 3(A)(i) is projected an image of one of the signal sources on an array, for example the image from a single ZMW. This image can be obtained, for example, using trans-illumination or using fluorescent emission from the ZMW either before or during an analytical reaction. In the case of FIG. 3(A) the image is circularly symmetric. FIG. 3(A)(ii) represents the image of the signal source onto the pixels, in which the highest intensity is represented by white, no intensity is represented by black, and intermediate intensities are represented by shades of gray. As illustrated in FIG. 3(A)(ii), the PSF for this signals source has its highest intensity in the center, with the intensity dropping off with distance from the centroid of the image. This measured PSF is then used to provide a weighting to the signals obtained from the 6 by 6 array of pixels in subsequent measurements such as during an analytical reaction. Note that the pixels at the perimeter of the pixel region are not completely black indicating that there is a measurable amount of light falling on them. FIG. 3(A)(iii) illustrates the pixel weights that are applied to the 6 by 6 array of pixels. In order to determine the PSF and define the software mask, a background correction is also generally applied.

The determination of the background signal for each feature can be provided by a number of methods such as 1) estimating the BG per pixel in an (e.g.) annulus outside the feature ROI in regions minimally impacted by spatial cross-talk from neighbouring features, 2) using a model of the PSF and solving for the BG signal under the PSF, 3) using fiducial locations that are otherwise identical to micromirrors but do not contain ZMW holes—these can give unbiased BG estimates. Quantifying their signal and using a fitted BG surface to these values across the camera FOV allows BG estimates to be made at all chip locations. Here, the background estimate indicates that due to stray light including background fluorescence, all of the pixels are receiving some level of background intensity. Subtracting this BG from the raw signal in the ROI and normalizing the integrated ROI intensity to 1 yields the PSF needed as part of the weighting function. When this correction is made the PSF indicates, for example, that the pixels on the perimeter of the ROI region are receiving substantially all of their intensity from background light, and substantially no light from the image of the ZMW. Thus, when the pixel weights are applied, the pixels beyond the outer perimeter of the 6 by 6 array are given no weight, i.e. a weighting factor of 0. The 4 pixels in the center are given the highest weighting. The pixels surrounding the four central pixels are provided with an intermediate weighting depending on the relative amount of light expected to fall on them relative to the other pixels in the 6 by 6 array.

When the 6 by 6 array of pixels is used to measure emitted light intensity from the signal source on an array during an analytical reaction, the set of weights shown in FIG. 3(A)(iii) are applied to the signals from the pixels. For example, the signal from these 36 pixels can be combined by summing up the measured intensity of each of the pixels times the pixel's weighting factor. This will provide an intensity measurement for that signal source on that detector for that period of time. The same process is repeated for each time period providing a trace over time showing the intensity from that signal source into the color channel for that detector. The trace will have a high sensitivity to pulses where the nucleotide corresponding to that color channel is associated with the enzyme, e.g. during nucleotide incorporation. This process for determining and using the PSF to calculate and apply weights can be performed for all of the signal sources on the array that are imaged onto the detector. When the PSFs are determined for each of the signal sources on the array, the application of the weights based on the set of PSFs produces a software mask that is applied to all of the pixels on the detector. The software mask defines which X by Y region of pixels on the detector are associated with each signal source on the array and defines the weighting for of pixels within the X by Y region so that when the signals corresponding to each signal source are obtained at a high signal to noise. A software mask can be determined and applied for each of the D detectors.

FIG. 3(B) illustrates the measurement of a PSF for a signal source on the array of signal sources in which the PSF from the signal source is not circularly symmetric. Onto the array of pixels in FIG. 3(B)(i) is imaged a signal source having an irregular PSF as shown in FIG. 3(B)(ii). The highest intensity is represented by white, no intensity is represented by black, and intermediate intensities are represented by shades of gray. The measured intensities are then used, along with the factors corresponding to background noise to determine a set of pixel weights to be applied in subsequent intensity measurements from that signal source. Here, significant signal intensity falls only on a 4 by 3 region within the 6 by 6 pixel region. The weighting that is given to the pixels within the region is provided based on the expected intensity on each of the pixels as provided by the measured PSF. In some cases, other factors such as noise or variance measurements and or estimates are used to determine the appropriate weighting factors. By applying the appropriate weighting factors, the measurement of the intensity from the signal source can be made with higher signal to noise than if the weighting factors were not applied.

In addition to applying the software mask, a number of other initial calibrations operations may be applied as step 102 of FIG. 1 Some of these initial calibration steps may be performed just once at the beginning of a run or on a more continuous basis during the run. The software mask can also be defined using calibration steps that are carried out well before the beginning of a run, such as at the initial production of the instrument, or as part of an ongoing calibration for the instrument which could be carried out at intervals such as annually, monthly, weekly, or once every set number of runs. These calibration steps can include such things as centroid determination, alignment, gridding, drift correction, initial background subtraction, noise parameter adjustment, frame-rate adjustment, etc. For the systems and processes of the invention, the calibration processes generally involve defining a set of pixel weights including defining a 2-dimensional software mask and setting noise or variance parameters in order to improve the signal to noise of the measurements. These weightings are applied to each of the D detectors in, the system. In some cases, the weights are applied on a pixel by pixel basis, and sometimes the weights are applied on a pixel region by pixel region basis wherein each pixel region represents a feature on the substrate array. Some of these initial calibration steps may involve communication from the processor back to the detector/camera, as discussed further below.

Whether the signal can be categorized as a significant signal pulse or event is determined at step 104. In some example systems, because of the small number of photons available for detection and because of the speed of detection, various statistical analysis techniques may be performed in determining whether a significant pulse has been detected.

In step 106, the data from each of the D detectors is combined using a spectral weighting matrix that provides for the relative signal level in each optical channel. This step is generally carried out on a feature by feature basis, for example aperture by aperture. The X by Y pixel region on each detector that corresponds to a given aperture is determined as described above in the application of the software mask. For example, a given label, label 1, may have been determined to have spectral weighting values for 4 detectors of 1, 0.5, 0.25, 0 for channels 1, 2, 3, and 4 respectively. If a pulse in a given aperture is identified as significant, and it has an intensity near 1 from detector 1, near 0.5 from detector 2, near 0.25 from detector 3 and near 0 from detector 4, the pulse likely indicates the presence of label 1 in the aperture.

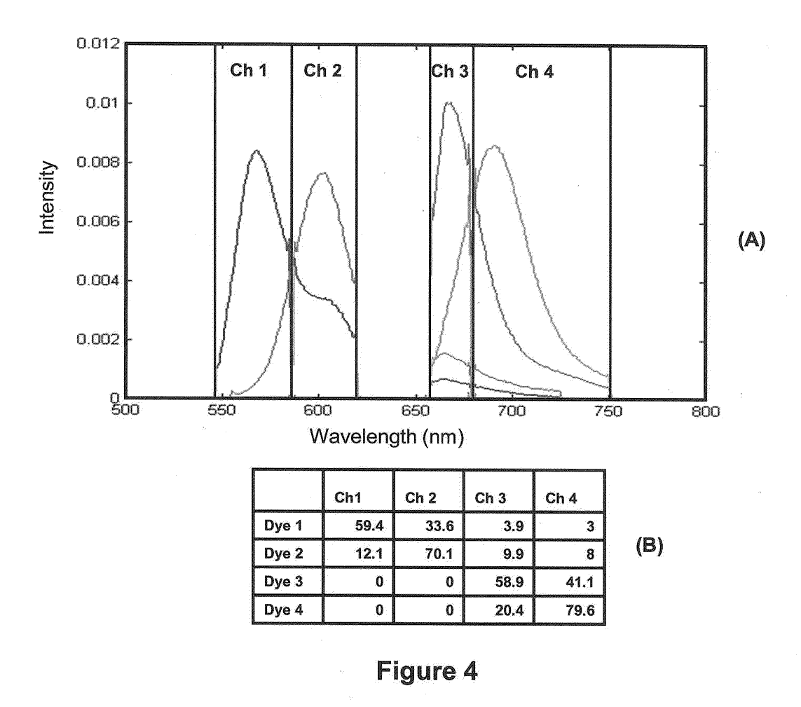

FIG. 4 provides an illustration of the preparation of a spectral matrix which allows for determining the identity of a given fluorescent signal by combining the information from each of the D detectors where each detector corresponds to a particular spectral channel. For the exemplary embodiment of FIG. 4, there are four detectors, each corresponding to a color channel. FIG. 4(A) shows intensity versus emission wavelength spectra for the four dyes used. A four dye system such as this can be used for nucleic acid sequencing where each of the dyes is attached to a different nucleotide analog, and the presence of each dye (in the form of a pulse) can indicate the incorporation of that particular nucleotide analog into a growing strand, thus identifying the complement of that nucleotide analog as the next base in the template nucleic acid being sequenced.

As can be seen, while each channel is associated primarily with one of the fluorescent dyes, there can be a significant contribution from neighboring dyes in that channel. This is due to the fact that the emission spectra are broad enough that they are not contained within a single channel. Using the emission spectra, a matrix can be constructed which allows for the measured intensities on each of the four detectors to be combined in order to identify the presence of the correct fluorescent dye. For example, in sequence determination, where the nucleotide associated with A660 is incorporated within a given ZMW, a pulse will be identified in the X by Y regions corresponding to that ZMW on the detectors corresponding both channel 3 and channel 4, but no corresponding pulse will be observed in the relevant X by Y regions of the detectors corresponding to channels 1 and 2. The signal in channel 3 will be higher than the peak in channel 4 by a ratio of about 59:41. The observation of such a peak will be strongly indicative of an incorporation event of the nucleotide corresponding to the A660 dye.

In some cases, the spectral matrix will vary depending on the position of the signal source, such as a ZMW on the array. Thus, in some cases, rather than applying a singe spectral matrix to the signal from each of the signals from the detector, a spectral matrix is determined on multiple locations across the detector. In some cases, a spectral matrix is determined and applied for each pixel. In some cases, a spectral matrix is determined and applied for each X by Y region of pixels corresponding to each signal source on the array. While the spectral matrix will generally vary across the array, in many cases, the amount of change in the spectral matrix within small regions of the detector will be small. In these cases, the spectral matrix need not be determined at each X by Y region, but can be obtained at representative regions across the detector and applied to surrounding X by Y regions.

Once a color channel is assigned to a given incorporation signal, that assignment is used to call either the base incorporated, or its complement in the template sequence, at step 108 of FIG. 1. The compilation of called bases is then subjected to additional processing at step 210 to provide linear sequence information, e.g., the successive sequence of nucleotides in the template sequence, assemble sequence fragments into longer contigs, or the like.

As noted above, the signal data is input into the processing system, e.g., an appropriately programmed computer or other processor. Signal data may input directly from a detection system, e.g., for real time signal processing, or it may be input from a signal data storage file or database. In some cases, e.g., where one is seeking immediate feedback on the performance of the detection system, adjusting detection or other experimental parameters, real-time signal processing will be employed. In some embodiments, signal data is stored from the detection system in an appropriate file or database and is subject to processing in post reaction or non-real time fashion.

The signal data used in conjunction with the present invention may be in a variety of forms. For example, the data may be numerical data representing intensity values for optical signals received at a given detector or detection point of an array based detector. Signal data may comprise image data from an imaging detector, such as a CCD, EMCCD, ICCD or CMOS sensor. In either event, signal data used according to specific embodiments of the invention generally includes both intensity level information and spectral information. The spatial information is obtained on each detector as that detector contains a 2-dimensional image of the surface of the substrate array. The spectral information is provided by combining the relative intensities from the different detectors that are each sensitive to a different color channel on a feature by feature basis between each of the detectors.

For the sequencing methods described above, there will be a certain amount of optical signal that is detected by the detection system that is not the result of a signal from an incorporation event. Such signal, referred to hereafter as “noise” may derive from a number of sources that may be internal to the monitored reaction, internal to the detection system and/or external to all of the above. Examples of noise internal to the reaction being monitored includes, e.g.: presence of fluorescent labels that are not associated with a detection event, e.g., liberated labels, labels associated with unincorporated bases in diffused in solution, bases associated with the complex but not incorporated; presence of multiple complexes in an individual observation volume or region; non-specific adsorption of dyes or nucleotides to the substrate or enzyme complex within an observation volume; contaminated nucleotide analogs, e.g., contaminated with other fluorescent components; other reaction components that may be weakly fluorescent; spectrally shifting dye components, e.g., as a result of reaction conditions; and the like.

Sources of noise internal to the detection system, but outside of the reaction mixture can include, e.g., reflected excitation radiation that bleeds through the filtering optics; scattered excitation or fluorescent radiation from the substrate or any of the optical components; spatial cross-talk of adjacent signal sources; auto-fluorescence of any or all of the optical components of the system; read noise from the detector, e.g., CCDs, gain register noise, e.g., for EMCCD cameras, and the like. Other system derived noise contributions can come from data processing issues, such as background correction errors, focus drift errors, autofocus errors, pulse frequency resolution, alignment errors, and the like. Still other noise contributions can derive from sources outside of the overall system, including ambient light interference, dust, and the like.

These noise components contribute to the background photons underlying any signal pulses that may be associated with an incorporation event. As such, the noise level will typically form the limit against which any signal pulses may be determined to be statistically significant.

Identification of noise contribution to overall signal data may be carried out by a number of methods, including, for example, signal monitoring in the absence of the reaction of interest, where any signal data is determined to be irrelevant. Alternatively, and preferably, a baseline signal is estimated and subtracted from the signal data that is produced by the system, so that the noise measurement is made upon and contemporaneously with the measurements on the reaction of interest. Generation and application of the baseline may be carried out by a number of means, which are described in greater detail below. Once these noise sources are characterized their total noise contribution to each pixel in the ROI can be estimated from a photonic noise model appropriate to the detector. Their variance is then used in conjunction with the PSF to that pixel to calculate an optimal weight to improve the SNR of the extracted signal.

In accordance with the present invention, signal processing methods distinguish between noise, as broadly applied to all non-significant pulse based signal events, and significant signal pulses that may, with a reasonable degree of confidence, be considered to be associated with, and thus can be tentatively identified as, an incorporation event. In the context of the present invention, a signal event is first classified as to whether it constitutes a significant signal pulse based upon whether such signal event meets any of a number of different pulse criteria. Once identified or classified as a significant pulse, the signal pulse may be further assessed to determine whether the signal pulse constitutes an incorporation event and may be called as a particular incorporated base. As will be appreciated, the basis for calling a particular signal event as a significant pulse, and ultimately as an incorporation event, will be subject to a certain amount of error, based upon a variety of parameters as generally set forth herein. As such, it will be appreciated that the aspects of the invention that involve classification of signal data as a pulse, and ultimately as an incorporation event or an identified base, are subject to the same or similar errors, and such nomenclature is used for purposes of discussion and as an indication that it is expected with a certain degree of confidence that the base called is the correct base in the sequence, and not as an indication of absolute certainty that the base called is actually the base in a given position in a given sequence.

One such signal pulse criterion is the ratio of the signals associated with the signal event in question to the level of all background noise (“signal to noise ratio” or “SNR”), which provides a measure of the confidence or statistical significance with which one can classify a signal event as a significant signal pulse. In distinguishing a significant pulse signal from systematic or other noise components, the signal generally must exceed a signal threshold level in one or more of a number of metrics, including for example, signal intensity, signal duration, temporal signal pulse shape, pulse spacing, and pulse spectral characteristics.

By way of a simplified example, signal data may be input into the processing system. If the signal data exceeds a signal threshold value in one or more of signal intensity and signal duration, it may be deemed a significant pulse signal. Similarly, if additional metrics are employed as thresholds, the signal may be compared against such metrics in identifying a particular signal event as a significant pulse. As will be appreciated, this comparison will typically involve at least one of the foregoing metrics, and preferably at least two such thresholds, and in many cases three or all four of the foregoing thresholds in identifying significant pulses.

Signal threshold values, whether in terms of signal intensity, signal duration, pulse shape, spacing or pulse spectral characteristics, or a combination of these, will generally be determined based upon expected signal profiles from prior experimental data, although in some cases, such thresholds may be identified from a percentage of overall signal data, where statistical evaluation indicates that such thresholding is appropriate. In particular, in some cases, a threshold signal intensity and/or signal duration may be set to exclude all but a certain fraction or percentage of the overall signal data, allowing a real-time setting of a threshold. Again, however, identification of the threshold level, in terms of percentage or absolute signal values, will generally correlate with previous experimental results. In alternative aspects, the signal thresholds may be determined in the context of a given evaluation. In particular, for example, a pulse intensity threshold may be based upon an absolute signal intensity, but such threshold would not take into account variations in signal background levels, e.g., through reagent diffusion, that might impact the threshold used, particularly in cases where the signal is relatively weak compared to the background level. As such, in certain aspects, the methods of the invention determine the background fluorescence of the particular reaction in question, including, in particular, the contribution of freely diffusing dyes or dye labeled analogs into a zero mode waveguide, and set the signal threshold above that actual background by the desired level, e.g., as a ratio of pulse intensity to background fluorophore diffusion, or by statistical methods, e.g., 5 sigma, or the like. By correcting for the actual reaction background, such as fluorophore diffusion background, the threshold is automatically calibrated against influences of variations in dye concentration, laser power, or the like. By reaction background is meant the level of background signal specifically associated with the reaction of interest and that would be expected to vary depending upon reaction conditions, as opposed to systemic contributions to background, e.g., autofluorescence of system or substrate components, laser bleedthrough, or the like.

In order to produce a software mask with optimized performance, it can be useful to include the contribution of the background signal in the definition of the pixel weights that comprise the software mask. This allows for setting the pixel weights such that the maximum amount of actual signal from the ZMW and the minimum amount of background is represented in the measured signal for a given ZMW on the array. Contributions to background noise can come from a variety of sources including the following: 1) Autofluorescence from the objective lens assembly, which can be a relatively flat background noise signal, or where there are micromirror features on the array, this background can have some enhancement within the micromirror regions, 2) chip or array autofluorescence, which can vary in intensity across the detector where the excitation source varies—for example, where an array of excitation beamlets is used to irradiate the array, the intensity of the autofluorescence will generally be higher in regions corresponding to the higher intensity signals. The chip autofluorescence may also vary between micromirror and the regions between the micromirrors and can in some cases have significant differences between cameras, as the autofluorescence can be frequency dependent. 3) Trans-illumination fluorescence, in which a solution containing fluorophores acts as a light source similar to a trans-illumination source, 4) Diffusion background from fluorophores that are freely diffusing in solution, and 5) Spatial cross-talk resulting from fluorescence into the image of a ZMW from a neighboring ZMW. While the use of micromirrors can significantly lower the amount of cross-talk from neighboring signal sources, such cross talk can sometimes be present, e.g. from the out of focus wings of the PSF from the ZMW. The background from these sources can be measured and/or estimated, and in some cases can be compensated for by incorporating the expected background signals into the set of weights that are applied to the pixels. In some cases the diffusion background is incorporated into the software mask. In some cases, the background signal can be separated into an in-focus component and an out-of-focus component. An aspect of the invention includes determining the background for one or more of these sources of background signal and incorporating the background signal in the definition of the software mask.

In some cases, the fluorescent signal from labels within the ZMWs will exhibit a different saturation characteristic to the fluorescent signals from background fluorescence such as autofluorescence from components in the optical system. Where this is the case, a modulated beam can be directed at the ZMW array in the presence of fluorescent labels where the beam has an intensity at some time points in the modulation in which the fluorescent labels, but not the autofluorescence signals will become saturated, resulting in the observation of two sets of signals, the set of signals from the dye being truncated due to saturation. This process can allow for the separation of useful fluorescence from the autofluorescence background.

In particularly preferred aspects that rely upon real-time detection of incorporation events, identification of a significant signal pulse may rely upon a signal profile that traverses thresholds in both signal intensity and signal duration. For example, when a signal is detected that crosses a lower intensity threshold in an increasing direction, ensuing signal data from the same set of detection elements, e.g., pixels, are monitored until the signal intensity crosses the same or a different intensity threshold in the decreasing direction. Once a peak of appropriate intensity is detected, the duration of the period during which it exceeded the intensity threshold or thresholds is compared against a duration threshold. Where a peak comprises a sufficiently intense signal of sufficient duration, it is called as a significant signal pulse.

In addition to, or as an alternative to using the intensity and duration thresholds, pulse classification may employ a number of other signal parameters in classifying pulses as significant. Such signal parameters include, e.g., pulse shape, spectral profile of the signal, e.g., pulse spectral centroid, pulse height, pulse diffusion ratio, pulse spacing, total signal levels, and the like.

Either following or prior to identification of a significant signal pulse, signal data may be correlated to a particular signal type. In the context of the optical detection schemes used in conjunction with the invention, this typically involves characterizing the spectral output of a label by the relative signal from the dye in each of the D color channels which are each directed to a single detector. This is generally done by obtaining and applying a spectral matrix having the relative intensities for a given label on each of the D detectors. The spectral matrix for a given label can vary across a detector, so in some embodiments, it is useful to define and apply a spectral matrix for each pixel, for each pixel region corresponding to a feature on the substrate array, or for different regions of pixels across the detector.

This approach to spectral separation can be contrasted with the approach taught, for example, in U.S. Patent Publication No. 2007/0036511, wherein the signal is spread into a spectral profile in one dimension, and is projected onto a detector such that the intensity across the pixels in one dimension is indicative of the spectral output of the label. These systems generally utilize a prism or wedge to spread the signal spectrally in one dimension, relying on the other dimension for spatial information. In the systems of the present invention, the 2-dimensional intensity is retained and can be determined at each detector, while the spectral information is obtained by combining the relative intensity of signals from a given feature that is obtained on each of the D detectors. An advantage of the methods and systems of the present invention is that the use of the 2-dimensional intensity profile allows for a more accurate measurement of the intensity from the signal source. Another advantage is that the use of D detectors, each sensitive to a different wavelength range can provide for a more accurate measurement of the spectral component, and therefore a more accurate determination of which different label is present. This can provide for more accurate base calling in single molecule sequencing.

In particular, the optical detection systems used in conjunction with the methods and processes of the invention are generally configured to receive optical signals that have distinguishable spectral profiles, where each spectrally distinguishable signal profile may generally be correlated to a different reaction event. In the case of nucleic acid sequencing, for example, each spectrally distinguishable signal may be correlated or indicative of a specific nucleotide incorporated or present at a given position of a nucleic acid sequence.

There are various approaches for determining the PSF for use in defining the software mask. The analytical instrument of the invention can generate data in the form of a time series of digital images. The time series can be referred to as a movie. Each frame of the series comprises four color image components, each generated by one of four detectors, which can be any suitable detector. As used herein, the detector is comprised of an array of pixels, and can comprise, for example, CMOS, CCD, or EMCCD detectors. In some embodiments, the frame rate is about 100˜Hz. Each image component comprises an array of digital pixel responses. The standard corrections (e.g., flat field, bias, gain, quantum efficiency) are first applied to the raw image data to produce a processed pixel response Rᵢⱼ for pixel i of camera j that estimates the number of photons incident on that pixel during a given exposure (after BG correction of the signal). In addition to the digitization noise inherent to the representation, each pixel response also can suffer the standard types of noise exhibited by digital image sensors, for example: photon shot noise, dark current noise, and read noise. It is not uncommon for one of these to dominate the others. Vᵢⱼ will denote the variance in a pixel that results from these sources of noise. From this input we can obtain an optimal estimate of the PSF. This estimate minimizes the chi-square of the fit of a model to the observed data. Insofar as the pixel noise is approximated as Gaussian, this estimate can be viewed as a maximum likelihood estimate. The model here is itself, at least in part, an empirical estimate of the apparent image profile of each ZMW on an array in which an analytical reaction is taking place. Such a profile is often referred to as a point-spread function PSF.

The PSF can be denoted as Pᵢⱼₖₗ and can be seen as the probability of a photon emitted by dye k in hole l landing in pixel i of camera j. For notational convenience, we index the camera pixels with a single integer. In practice two integers are typically used for this purpose. We assume that we have determined an accurate estimate of the PSF through calibration procedures. If the number of photons emitted by dye k from hole l during a particular frame integration time is Φₖₗ, then our PSF model predicts that the number of photons incident on pixel i of camera j is ΦₖₗPᵢⱼₖₗ. To conserve photons, we require that

$${\sum }_{i , j} {P}_{ijkl} = 1 , ∀ k , l .$$

In reality, photons will be lost to various physical effects (e.g., small opacity in the optics). We assume, however, that such effects are constant and can be effectively normalized away. Moreover, we are not particularly concerned with estimating the absolute photon flux. Our primary goal is to accurately estimate the relative number of photons from frame to frame of the movie. The object function for estimation is

$${χ}_{k , l}^{2} = {\sum }_{i , j} \frac{{( {Φ}_{kl} {P}_{ijkl} - {R}_{ij} )}^{2}}{{V}_{ij}} .$$

Our estimate Fᵢⱼₖₗ of Φₖₗ is determined by the condition

$${[ \frac{\partial {χ}_{kl}^{2}}{\partial {Φ}_{kl}} ]}_{{Φ}_{ kl} = {F}_{kl}} = 0.$$

From which it can be shown

$${F}_{kl} = {\sum }_{i , j} {w}_{ijkl} \frac{{R}_{ij}}{{P}_{ijkl}} ,$$

where ωᵢⱼₖₗ=CₖₗPᵢⱼₖₗ²/Vᵢⱼ, with normalization coefficient Cₖₗ defined by Σ_{i,j}ωᵢⱼₖₗ=1.

$${C}_{kl}^{- 1} = {\sum }_{i , j} {P}_{ijkl}^{2} / {V}_{ij}$$

The equation for Fₖₗ above can be interpreted as a weighted average of numerous estimates (Rᵢⱼ/Pᵢⱼₖₗ) of the number of total number of photons Φₖₗ in each feature. In a trivial case, the sum could extend over only one pixel. In practice, it usually extends over a region I containing a reasonable number (e.g. 5 to 100) of pixels. If the PSF is known with relatively high precision, the random error of the estimate is dominated by noise in the pixel responses,

$${σ}_{{F}_{kl}}^{2} = {\sum }_{i , j} {( \frac{\partial {F}_{kl}}{\partial {R}_{ij}} )}^{2} {σ}_{{R}_{ij}}^{2}$$

Since σ²Rᵢⱼ=Vᵢⱼ, then σ²Fₖₗ=Cₖₗ.

In some cases, for example for ease of computation and calibration, it is useful to factorize and approximate the PSF, for example as

Pᵢⱼₖₗ=QᵢⱼₖₗSⱼₖₗ≈QᵢⱼₗSⱼₖₗ

Sᵢⱼₖₗ represents the probability that a photon emitted by dye k in ZMW l is detected in camera j. Where a set of dichroics effectively act as narrow bandpass filters for each camera, Sᵢⱼₖₗ represents a sort of filter response for the dyes. Qᵢⱼₖₗ represents the conditional probability that a photon emitted by dye k in ZMW l is detected by pixel i, given that it is detected in camera j. This probability may depend on the dye emitting the photon, but the dependence may be weak, in which case Qᵢⱼₖₗ is approximated by Qᵢⱼₗ. Then Qᵢⱼₗ represents the spatial component of Pᵢⱼₖₗ, while Sⱼₖₗ represents the spectral component.

Using these approximations, we can separate the S and Q terms in the PSF estimate as:

$${F}_{kl} = {\sum }_{j} {x}_{jkl} \frac{{G}_{jl}}{{S}_{jkl}}$$

$${G}_{jl} = {\sum }_{i} {y}_{ijl} \frac{{R}_{ij}}{{Q}_{ijl}}$$

$$where$$

$${y}_{ijl} = {D}_{jl} {Q}_{ijl}^{2} / {V}_{ij}$$

$${D}_{jl}^{- 1} = {\sum }_{i} {Q}_{ijl}^{2} / {V}_{ij}$$

are the dye-independent spatial-variance weights and

$${x}_{jkl} = {C}_{kl} {S}_{jkl}^{2} / {D}_{jl}$$

$${C}_{kl}^{- 1} = {\sum }_{i} {S}_{jkl}^{2} / {D}_{jl}$$

are the spectral-variance weights. Gⱼₗ can be viewed as an estimate of the number of photons emitted from ZMW l and detected at camera j. Note that the variance V can be estimated using the calibration and noise estimation strategies described herein.

As noted above, because the separation of labels into the spectral channels generally results in some portion of emitted light from a label into neighboring channels, and bemuse there is some noise in the system, the comparison of a given signal's relative intensity profile on each of the D detectors with the spectral matrix for the various colors of signals will assess the confidence with which a color may be assigned to a given signal event, based upon a number of parameters. By way of example, whether a given set of relative intensities on each of the D detectors is identified as matching one of the standard spectral matrices may be determined by subjecting the comparison to any of a variety of statistical correlation evaluations including, e.g., cross-correlation tests, χ², least squares fit, and the like.

As will be appreciated, the steps of incorporation signal identification and color assignment may be performed in either order and are generally not dependent upon each other. Restated, one may first assign a color to the signal before categorizing it as a significant pulse, or alternatively, one may first categorize a signal as a significant pulse and then assign a color to that pulse.

Once a particular signal is identified as a significant pulse and is assigned a particular spectrum, the spectrally assigned pulse may be further assessed to determine whether the pulse can be called an incorporation event and, as a result, call the base incorporated in the nascent strand, or its complement in the template sequence. Calling of bases from color assigned pulse data will typically employ tests that again identify the confidence level with which a base is called. Typically, such tests will take into account the data environment in which a signal was received, including a number of the same data parameters used in identifying significant pulses, etc. For example, such tests may include considerations of background signal levels, adjacent pulse signal parameters (spacing, intensity, duration, etc.), spectral image resolution, and a variety of other parameters. Such data may be used to assign a score to a given base call for a color assigned signal pulse, where such scores are correlative of a probability that the base called is incorrect, e.g., 1 in 100 (99% accurate), 1 in 1000 (99.9% accurate), 1 in 10,000 (99.99% accurate), 1 in 100,000 (99.999% accurate), or even greater. Similar to PHRED or similar type scoring for chromatographically derived sequence data, such scores may be used to provide an indication of accuracy for sequencing data and/or filter out sequence information of insufficient accuracy.

Once a base is called with sufficient accuracy, subsequent bases called in the same sequencing run, and in the same primer extension reaction, may then be appended to each previously called base to provide a sequence of bases in the overall sequence of the template or nascent strand. Iterative processing and further data processing, as described in greater detail below, can be used to fill in any blanks, correct any erroneously called bases, or the like for a given sequence.

While the foregoing process generally describes the processes of the invention, additional detail is provided with reference to an exemplary sequencing process, below.

### II. Sequencing by Incorporation Processes and Systems

The present invention is generally directed to novel processes, and particularly processes that include computer implemented processes, software and systems for monitoring and characterizing optical signals from analytical systems, and particularly systems that produce signals related to the sequence of nucleic acids in a target or template nucleic acid sequence, using a sequencing by incorporation process. The present invention is also generally directed to novel processes for analyzing optical and associated data from sequencing by incorporation processes to ultimately determine a nucleotide base sequence (also referred to herein as “base calling”). The present invention is also generally directed to novel processes for analyzing sequencing by incorporation processes from many reactions locations in real time.

In sequencing by incorporation methods, the identity of the sequence of nucleotides in a template nucleic acid sequence is determined by identifying each complementary base that is added to a nascent strand being synthesized against the template sequence, as such bases are added. While detection of added bases may be a result of detecting a byproduct of the synthesis or extension reaction, e.g., detecting released pyrophosphate, in many systems and processes, added bases are labeled with fluorescent dyes that permit their detection. By uniquely labeling each base with a distinguishable fluorescent dye, one attaches a distinctive detectable characteristic to each dye that is incorporated, and as a result provides a basis for identification of an incorporated base, and by extension, its complementary base upon the template sequence.

A number of sequencing by incorporation methods utilize a solid phase immobilized synthesis complex that includes a DNA polymerase enzyme, a template nucleic acid sequence, and a primer sequence that is complementary to a portion of the template sequence. The fluorescently labeled nucleotides are then added to the immobilized complex and if complementary to the next base in the template adjacent to the primer sequence, they are incorporated onto the 5′ end of the primer as an extension reaction product.

In some cases, the labeled bases are added under conditions that prevent more than a single nucleotide addition. Typically, this is accomplished through the inclusion of a removable extension terminating group on the 5′ position of the added nucleotide, which prevents any further extension reactions. In some cases, the removable terminating group may include the fluorescent label. In this context, the immobilized complex is interrogated with one or more labeled nucleotide analogs. When a labeled analog is added, the extension reaction stops. The complex is then washed to eliminate all unincorporated labeled nucleotides. Incorporation is then determined based upon the presence of a particular fluorescent label with the immobilized complex, indicating incorporation of the base that was so labeled. The removable chain terminating group and the label, which in some cases may comprise the same group, are then removed from the extension product and the reaction and interrogation is repeated, stepwise, along the template sequence.

In an alternative and preferred aspect, incorporation events are detected in real-time as the bases are incorporated into the extension product. Briefly, this can be accomplished by providing the complex immobilized within an optically confined space or otherwise resolved as an individual molecular complex. Nucleotide analogs that include fluorescent labels coupled to the polyphosphate chain of the analog are then exposed to the complex. Upon incorporation, the nucleotide along with its label is retained by the complex for a time and in a manner that permits its detection that is distinguishable from detection of random diffusion of unincorporated bases. Upon completion of incorporation, all but the alpha phosphate group of the nucleotide is cleaved away, liberating the label from retention by the complex, and diffusing the signal from that label. Thus, during an incorporation event, a complementary nucleotide analog including its fluorescent labels is effectively “immobilized” for a time at the incorporation site, and then the fluorescent label is subsequently released and diffuses away when incorporation is completed. According to specific embodiments of the invention, detecting the localized “pulses” of florescent tags at the incorporation site, and distinguishing those pulses from a variety of other signals and background noise as described below, allows the invention to effective call bases is real-time as they are being incorporated. In conjunction with optical confinements and/or single molecule resolution techniques, the signal resulting from incorporation can have one or more of increased intensity and duration as compared to random diffusion events and/or other non-incorporation events.

In all of the foregoing aspects, optical signal data is required to be processed to indicate real incorporation events as compared to other signals derived from non-incorporation events, and to identify the bases that are incorporated in those real incorporation events. The processing requirements become even greater where multiple different colored labels are used in interrogating larger and larger numbers of immobilized complexes arrayed over reaction substrates.

In addition to performing nucleic acid sequencing, the methods and systems of the invention can also be used for other analytical reactions carried out within arrays of nanostructures on a substrate. For example, nanoscale apertures can act as zero mode waveguides for obtaining high signal levels from low numbers of molecules, even to the level of single molecules. See, for example, U.S. Pat. No. 6,917,726, the full disclosure of which is incorporated herein by reference for all purposes. Monitoring reactions at a single molecule level can provide information that is not available from bulk measurements, as the kinetic steps of a single molecule can be observed without the averaging that occurs when observing an ensemble of molecules. Thus the arrays of nanoscale apertures described here can be used to observe single molecule reactions of many types. In particular, the observation of biological or biochemical reactions at the single molecule level is of significant interest. One aspect of the nanoscale aperture or ZMW structures, is that they allow for the monitoring of an association event by labeled entities in solution with another molecule that is immobilized within the aperture. Because of the optical properties of the nanoscale apertures, the association event can be detected even in the presence of background fluorescence from the labeled freely diffusing labeled entities.

The association events that can be monitored in the nanoscale aperture arrays include a binding pair such as a receptor-ligand, enzyme-substrate, antibody-antigen, or a hybridization interaction The binding pair can be nucleic acid to nucleic acid, e g DNA/DNA, DNA/RNA, RNA/DNA, RNA/RNA, RNA The binding pair can be a nucleic acid and a polypeptide, e g DNA/polypeptide and RNA/polypeptide, such as a sequence specific DNA binding protein. The binding pair can be any nucleic acid and a small molecule, e g RNA/small molecule, DNA/small molecule. The binding pair can be any nucleic acid and synthetic DNA/RNA binding ligands (such as polyamides) capable of sequence-specific DNA or RNA recognition. The binding pair can be a protein and a small molecule or a small molecule and a protein, e g an enzyme or an antibody and a small molecule. In particular, the association events can be that of an enzyme and a substrate for the enzyme, allowing the measurement of not only whether a binding event occurs, but of specific kinetic aspects of the enzyme activity while the substrate is bound.

In other embodiments, the binding pair can comprise a carbohydrate and protein or a protein and a carbohydrate, a carbohydrate and a carbohydrate, a carbohydrate and a lipid, or lipid and a carbohydrate, a lipid and a protein, or a protein and a lipid, a lipid and a lipid. The binding pair can comprise natural binding compounds such as natural enzymes and antibodies, and synthetic binding compounds. The probe/analyte binding pair or analyte/probe binding pair can be synthetic protein binding ligands and proteins or proteins and synthetic binding ligands, synthetic carbohydrate binding ligands and carbohydrates or carbohydrates and synthetic carbohydrate binding ligands, synthetic lipid binding ligands or lipids and lipids and synthetic lipid binding ligands.

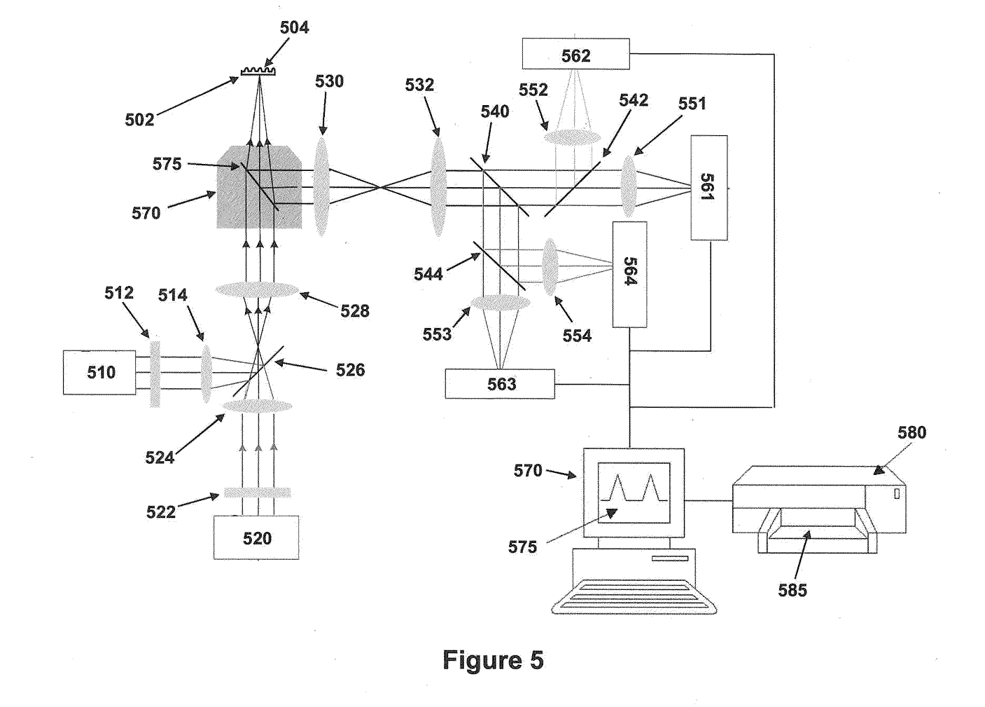

For purposes of the present invention, the processes and systems will be described with reference to detection of incorporation events in a real time, sequence by incorporation process, e.g., as described in U.S. Pat. Nos. 7,056,661, 7,052,847, 7,033,764 and 7,056,676 (the full disclosures of which are incorporated herein by reference in their entirety for all purposes), when carried out in arrays of discrete reaction regions or locations. An exemplary sequencing system for use in conjunction with the invention is shown in FIG. 5. While the system is described with respect to sequencing, it is understood that the system can be used for analyzing other reactions than those of sequencing. As shown, the system includes a substrate 502 that includes a plurality of discrete sources of optical signals, e.g., reaction wells, apertures, or optical confinements or reaction locations 504. In typical systems, reaction locations 504 are regularly spaced and thus substrate 502 can also be understood as an array 502 of reaction locations 504. The array 502 can comprise a transparent substrate having cladding layer on its top surface with an array of nanoscale apertures extending through the cladding to the transparent substrate. This configuration allows for one or more samples to be added to the top surface of the array, and for the array to be observed through the transparent substrate from below, such that only the light from the apertures is observed. The array can be illuminated from below as shown in FIG. 5, and in some embodiments, the array can also be illuminated from above (not shown in FIG. 5).

For illumination from below, one or more excitation light sources, e.g., lasers 510 and 520, are provided in the system and positioned to direct excitation radiation at the various signal sources. Here, two lasers are used in order to provide different excitation wavelengths, for example with one laser 510 providing illumination in the red, and laser 520 providing illumination in the green. The use of multiple laser excitation sources allows for the optimal excitation of multiple labels in a sample in contact with the array. The excitation illumination can be a flood illumination, or can be directed to discrete regions on the array, for example, by breaking the excitation beam into an array of beamlets, each beamlet directed to a feature on the array. In order to break the excitations beams into an array of beamlets, a diffractive optical element (DOE). In the system of FIG. 5, the light from excitation sources 510 and 520 is sent through DOE components 512 and 522 respectively. The use of a DOE for providing an array of beamlets is provided, e.g. in U.S. Pat. No. 7,714,303, which is incorporated by reference herein in its entirety. Excitation light is then passed through illumination relay lenses 514 and 524 to interact with dichroic 526. In the system of FIG. 5, the red light from laser 510 is reflected off of dichroic 526, and the green light from laser 520 is directed through the dichroic 526. The excitation light is then passed through illumination tube lens 528 into objective lens 570 and onto the array 502.

Emitted signals from sources 504 are then collected by the optical components, e.g., objective 570, comprising dichroic element 575 which allows the illumination light to pass through and reflects the excitation light. The emitted light passes through collection tube lens 530 and collection relay lens 532. The emitted light is then separated into D different spectral channels, and each spectral channel is directed to a different detector. In the system of FIG. 5, the light is separated into four different channels, each channel corresponding predominantly to one of four labels to be detected in the sample. Thus, the system allows the user to obtain four two dimensional images, each image corresponding to one of the four labels. In order to separate the light into the four spectral channels, dichroics 540, 542, and 544 are used. Dichroic 540 allows the light for channels 1 and 2 to pass while reflecting the light for channels 3 and 4. Dichroic 542 allows the light for channel 1 to pass, through collection imaging lens 551 to detector 561, and reflects the light for channel 2 through collection imaging lens 552 to detector 562. Dichroic 544 allows the light for channel 3 to pass, through collection imaging lens 553 onto detector 563, and reflects the light for channel 4 through collection illumination lens 554 onto detector 564. Each of the detectors 561-564 comprise arrays of pixels. The detectors can be, for example, CMOS, EMCCD, or CCD arrays. Each of the detectors obtains 2-dimensional images of the channel that is directed to that detector. The data from those signals is transmitted to an appropriate data processing unit, e.g., computer 570, where the data is subjected to processing, interpretation, and analysis. The data processing unit is configured to process the data both pixel by pixel and pixel region by pixel region, where each pixel region corresponds to a feature on the substrate. The data processing unit can receive data from calibration runs in order to define software mask pixel weighting, spectral weighting, and noise parameters. These parameters and weightings can be applied to signals that are measured on the detectors during an analytical reaction such as during sequencing. In some embodiments, the data processing unit is configured to define and apply software mask pixel weighting, spectral weighting, and noise parameters that are determined and then applied during an analytical reaction such as during sequencing.

Analyzed and processed obtained from the analytical reactions can ultimately be presented in a user ready format, e.g., on display 575, printout 585 from printer 580, or the like, or may be stored in an appropriate database, transmitted to another computer system, or recorded onto tangible media for further analysis and/or later review. Connection of the detector to the computer may take on a variety of different forms. For example, in preferred aspects, the detector is coupled to appropriate Analog to Digital (A/D) converter that is then coupled to an appropriate connector in the computer. Such connections may be standard USB connections, Firewire® connections, Ethernet connections or other high speed data connections. In other cases, the detector or camera may be formatted to provide output in a digital format and be readily connected to the computer without any intermediate components.

This system, and other hardware descriptions herein, are provided solely as a specific example of sample handling and image capture hardware to provide a better understanding of the invention. It should be understood, however, that the present invention is directed to data analysis and interpretation of a wide variety of real-time florescent detecting systems, including systems that use substantially different illumination optics, systems that include different detector elements (e.g., EB-CMOS detectors, CCD's, etc.), and/or systems that localize a template sequence other than using the zero mode wave-guides described herein.

In the context of the nucleic acid sequencing methods described herein, it will be appreciated that the signal sources each represent sequencing reactions, and particularly, polymerase mediated, template dependent primer extension reactions, where in preferred aspects, each base incorporation event results in a prolonged illumination (or localization) of one of four differentially labeled nucleotides being incorporated, so as to yield a recognizable pulse that carries a distinguishable spectral profile or color.

As noted previously, the present invention is generally directed to machine or computer implemented processes, and/or software incorporated onto a computer readable medium instructing such processes, as set forth in greater detail below. As such, signal data generated by the reactions and optical systems described above, is input or otherwise received into a computer or other data processor, and subjected to one or more of the various process steps or components set forth below. Once these processes are carried out, the resulting output of the computer implemented processes may be produced in a tangible or observable format, e.g., printed in a user readable report, displayed upon a computer display, or it may be stored in one or more databases for later evaluation, processing, reporting or the like, or it may be retained by the computer or transmitted to a different computer for use in configuring subsequent reactions or data processes.

Computers for use in carrying out the processes of the invention can range from personal computers such as PC or Macintosh® type computers running Intel Pentium or DuoCore processors, to workstations, laboratory equipment, or high speed servers, running UNIX, LINUX, Windows®, or other systems. Logic processing of the invention may be performed entirely by general purposes logic processors (such as CPU's) executing software and/or firmware logic instructions; or entirely by special purposes logic processing circuits (such as ASICs) incorporated into laboratory or diagnostic systems or camera systems which may also include software or firmware elements; or by a combination of general purpose and special purpose logic circuits. Data formats for the signal data may comprise any convenient format, including digital image based data formats, such as JPEG, GIF, BMP, TIFF, or other convenient formats, while video based formats, such as avi, mpeg, mov, rmv, or other video formats may be employed. The software processes of the invention may generally be programmed in a variety of programming languages including, e.g., Matlab, C, C++, C#, NET, Visual Basic, Python, JAVA, CGI, and the like.

While described in terms of a particular sequencing by incorporation process or system, it will be appreciated that certain aspects of the processes of the invention may be applied to a broader range of analytical reactions or other operations and varying system configurations than those described for exemplary purposes.

### III. Exemplary Sequencing by Incorporation Process and System

The processes described above are further described in the context of a particularly preferred sequence-by-incorporation analysis using as a source of signals, a gridded array of optically confined, polymerase/template/primer complexes that are exposed to four different nucleotide analogs, e.g., A, T, G and C, that are each labeled at the terminal phosphate group of either a tri, tetra or pentaphosphate chain of the nucleotide or nucleotide analog (e.g., as a phosphate labeled nucleoside triphosphate, tetraphosphate or pentaphosphate). In preferred aspects, the optically confined complexes are provided within the observation volumes of discrete zero mode waveguide (ZMW) cores in an arrayed format, Although described in terms of optically confined reaction regions, it will be appreciated that the methods of the invention in whole or in part may be applicable to other types of sequencing by incorporation reactions and particularly those based upon immobilized reaction complexes, and more particularly, those employing optically resolvable single molecule complexes, e.g., including a single polymerase/template/primer complex.

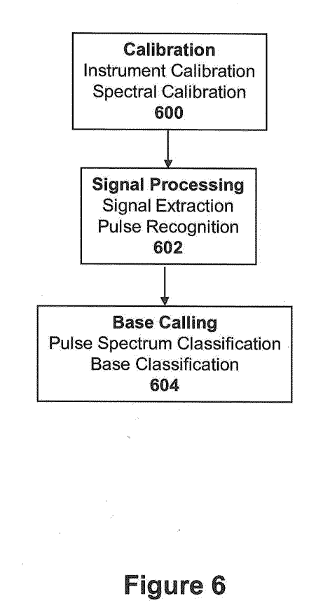

An example of an overall sequence process comprised of three general process categories is generally shown in FIG. 6. As shown, the process includes an initial calibration step 600, in which the system is calibrated from both an instrument standpoint and a reaction standpoint, e.g., to adjust for consistent noise sources, and calibrated for color identification, e.g., using standard dye or label sets. As part of this calibration a, spectral matrix for each of the four labels will be obtained, and noise calibrations, including calibration of the detector will be performed. Once an actual sequencing data run commences, the signal data from the system is subjected to initial signal processing at step 602, to identify significant signal events or pulses and to extract spectral signals from the signal data. In this step the software mask, and the noise corrections are applied to the data to improve the signal to noise. Following the initial signal processing, classified pulses are then assessed at step 404 to classify signal data by applying the spectral matrix to the data from the four detectors as corresponding to a given spectral signal event, and consequently as corresponding to incorporation of a particular base in order to identify its complement in the nucleic acid template.

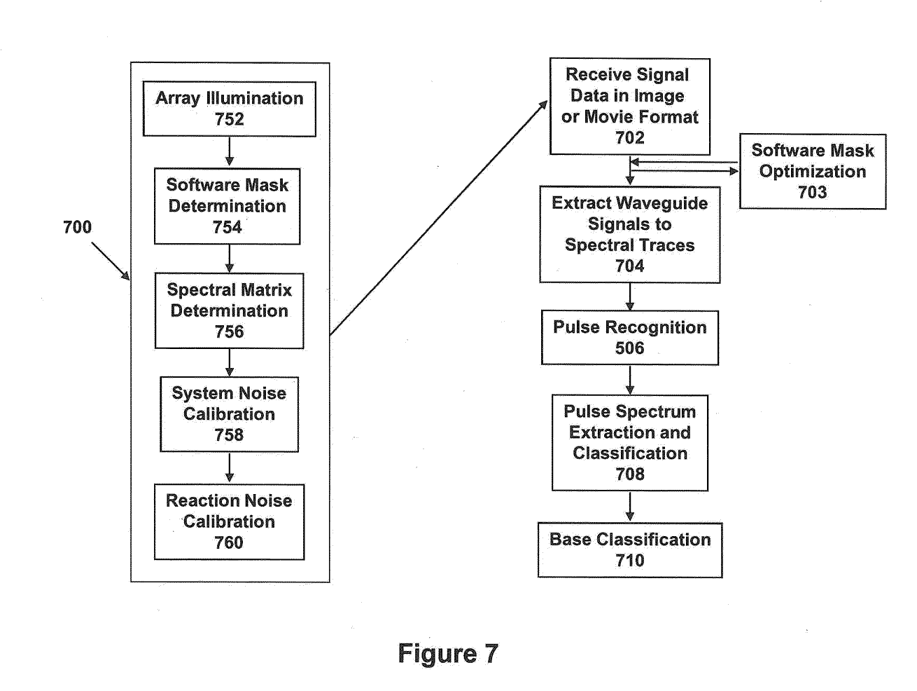

This exemplary, overall process is schematically illustrated in greater detail in the flow chart of FIG. 7. As shown, the system is initially calibrated to provide identification of the signals associated with each discrete signal source, to identify within that signal the most relevant signal portion, and to associate spectral information with different signal profiles. This calibration process, provided in greater detail below, is indicated at step 700, and is typically precedent and supplementary to the process of signal data processing from actual sequencing runs. The calibration process can involve illumination of the array of confinements 752, software mask determination 754, spectral matrix determination 756, system noise calibration 758, and in some cases, reaction noise calibration 760.

Following receipt of the signal data at step 702, the signal image or movie files for a given run are converted to spectral data at step 704 by comparing the overall signal data to the spectral matrix created in step 700. In some cases, data is also acquired and used for optimization of the software mask 703 that was determined during calibration. Performing software mask determination and optimization while the reaction is occurring is described in more detail herein. In some cases, signals received from each aperture are converted into D two dimensional time-series traces, one for each detector. As a result, the output of the conversion or extraction step is a series of individual movies or traces that indicate the different spectral signal components over time, e.g., as a series of D signal traces. For a typical four-color sequencing process, this will typically result in four different traces, where each trace represents the signal spectrum correlated with a different standard spectral image matrix. Once the spectrally discrete traces from each of the four detectors are obtained, the different traces are subjected to a pulse recognition or classification process at step 706. As noted above, in particularly preferred aspects, the pulse recognition process identifies significant signal pulses (e.g., pulses that meet criteria of significance for assessment to determine if they are associated with an incorporation event) in each trace, and distinguishes those from background or noise signals, e.g., those resulting from normal diffusion of unincorporated label molecules or labeled nucleotides into the observation volume, non-specific adsorption of labels or analogs within or near the observation volume, or the like. The pulse recognition process, as described in greater detail, below, identifies significant pulses based upon a number of signal characteristics as described above, including whether such signals meet signal thresholds described above (intensity, duration, temporal pulse shape, pulse spacing and spectral characteristics). Once a pulse is initially identified as significant, the time collapsed spectrum for a given significant pulse is extracted and classified at step 708 by correlating the pulse spectrum to the standard spectral matrix for the various signal possibilities, e.g., dye colors. For example, in this process, the statistical significance of the fit of the pulse spectral image may be calculated against those spectral images for the 4 different standard dye images, e.g., using a χ² test, or the like.

Once a significant pulse is correlated to a given label, the pulse is then subjected to the base classification process at step 710, where the spectrum assigned pulse data is further filtered based upon one or more of a number of signal parameters, which provide a basis of classification of the signal as a particular base (also referred to herein as a base classifier). The base classifier will typically comprise an algorithm that assesses the one or more signal parameters in order to classify the particular pulse as being correlative of a given base incorporation event. By way of example, such algorithms will typically comprise a multi-parameter fit process to determine whether a spectrum assigned signal pulse corresponds to an incorporation event within a selected probability range, as described in greater detail, below.

### A. Calibration

### 1. Software Mask Determination

As noted previously, the processes of the invention are particularly useful in processing signal data from arrays of optically confined sequencing or other optically monitored reactions. In particular, the systems and processes of the invention are particularly preferred for use with arrays of zero mode waveguides in which polymerase mediated, template directed primer extension reactions are occurring, where the addition of a nucleotide to an extending primer gives rise to a fluorescent signaling event. The signals emanating from the various signal sources on the array are then imaged onto an imaging detector, such as a CCD, ICCD, EMCCD or CMOS based detector array. As a result, prior to running a sequencing experiment, it is typically desirable to calibrate the system to the locations of the different zero mode waveguides, apertures (or other signal sources in other processes) in the overall array, or more importantly, the position upon the detector at which the different signals from each signal source are imaged.

In addition to identifying the location of each signal source within the substrate array, we have found that it in order to improve signal to noise, it is also desirable to define the shape of the image of the signal source in order to obtain the most signal from the pixels that are in the region expected to give the highest intensity from the source, and to obtain the least amount of signal from pixels expected to be away from the highest intensity portion of the image of the signal source. The 2-dimensional map that defines the weighting of each set of pixels associated with each signal source on the array is referred to herein as a software mask. One approach to constructing the software mask is to first define a location, e.g. a centroid for each the image of each signal source (gridding), and then to assign a point spread function (PSF) for each signal source.

Gridding is used to define the locations of the signal sources on the array. The location of the signal sources can be obtained 1) by calibration before the sequencing reaction, 2) during the sequencing reaction, or 3) using a combination of both measurements made before and during the reaction. In some cases, the data for both gridding and PSF determination is determined from the same set of image data. Defining the location of the signal sources generally involves assigning a two-dimensional X by Y region of pixels in each of the four detectors which corresponds to a given signal source, and defining a centroid for the image within the X by Y region. The signal sources can be apertures or ZMWs arranged in a regular pattern on the substrate such that the image of each aperture will fall into an X by Y region on each of the four detectors. Where the PSF is determined while the analytical reaction is in contact with the array of ZMWs, the signal from background fluorescence from diffusing fluorophores, or signal from the analytical reaction such as the sequencing reaction can be used to determine the PSF. As these signals are generally not particularly strong, the signals are usually integrated over a number of frames, and then combined in order to determine the PSF. In some cases, the PSF can be determined by integrating signals over a span of about 1 second to about 60 seconds. In some cases, the PSF can be determined by integrating signals over a span of about 2 second to about 30 seconds. The PSF calculated by subtracting a BG estimate from the raw signal intensities. This BG estimate may come locally close to the ROI of the signal, from a model fit that comprises signal and BG components or from fiducial signals do not contain signal of interest (e.g. features with no ZMWs). After BG correction the PSF is normalized so that all pixels associated with the signal of interest sum to 1. In some cases, some of the flux in a given X by Y region is due to cross talk from nearby signal sources on the array. This is the case, for example, when the signal sources on the array are close together. In some embodiments, the software mask takes into account the cross-talk from nearby signal sources in applying the weighting factors to the pixels. The cross-talk can be incorporated, for example, by determining the light contribution to cross-talk in a given X by Y region, and creating a table of cross-talk coefficients to be applied as part of the software mask. The determination of cross-talk coefficients can be determined, for example, by providing a ZMW array in which some of the ZMWs are absent, e.g. where half of the ZMWs are absent.

In some cases, the PSF measurements made during the analytical reaction will not completely define the PSF for each ZMW, but will only update certain parameters of the PSF. For example, in some cases, measurements during the reaction will be used to update the X/Y motion, rotation magnification, or defocusing, while the other aspects of the PSF, such as the shape and intensity drop-off would be fixed. This allows for the update to compensate for drift while not utilizing the resources necessary for completely re-defining the PSF. In some cases, the parameters for compensation of drift can be measured and applied across the field of view for all of the pixels.

In locating the image of the different signal sources on the detector, the array is typically illuminated so as to provide an imaged signal associated with it on the detector. In the case of an array of ZMWs (zero mode waveguides), the array can be trans-illuminated through the waveguide using a reference light source, or it can be imaged from below with excitation/emission optics in order to provide the location of the ZMWs. The trans-illumination light source may be a broad band light source imaged onto the detector, or may be made up of a set of narrow band emitting sources such as lasers or LEDS. The transmission light is imaged through the detection optics onto each of the four detectors, providing an image for defining a software mask for each detector. Such trans-illumination provides for high signal to noise levels for the image, allowing for accurate centroid estimation for gridding and point spread function estimation.

The imaged signals are then aligned to the known spacing of image sources on the substrate array optionally employing registration marks incorporated into the array. For example, in preferred aspects, rows of ZMWs in an array will include one or more blank spaces in place of a ZMW, where the blanks will be spaced at regular, known intervals, for alignment. Other registration marks might include regularly spaced image sources that are separate from the ZMWs, but are at known locations and spacing relative to the ZMWs in the array to permit alignment of the image to the array. Such image sources may include apertures like ZMWs, or may include fluorescent or luminescent marks that provide a signal event that can be used for alignment. In, some cases the registration marks can comprise regularly spaced arrays of ZMWs, for example with a larger aperture size than the other ZMWs on the array. The gridding step also permits the identification and calibration of the system to take into account any artifacts in a given ZMW array, e.g., blank ZMWs other than registration blanks, irregularly spaced ZMWs, or the like. Gridding is performed for each of the four detectors to form four separate grid maps which will be different for each detector. Each grid map will compensate for the different optical properties of the optical systems that direct the light to each detector. In some cases, a de-novo gridding will be performed as a calibration of the instrument using, for example a bivariat polynomial in order to produce least squares fit to map the identified features on the image with the expected features on the substrate array. This fit can be performed with a number of different parameters to take into account distortions in the optical systems or differences in the optical system from the center to the edges of the image. A reference mode gridding procedure can then be performed allowing some parameters of the earlier operation to be varied while other parameters remain fixed. For example, a reference gridding procedure may allow for rotation, translation in x and y, and isotropic magnification to be varied to produce the most reliable grid, while relying on the parameters obtained in de-novo gridding in place to correct for other image parameters.

In some embodiments, a PSF is defined for each signal source. This PSF can be obtained by measuring either a transmitted image or measuring an emitted fluorescent image, or using a combination of both images. This PSF can be obtained either in calibration prior to carrying out a sequencing run, or can be obtained during a sequencing run using the diffusion background fluorescent signals, the pulse signals, or a combination of both of these. In some cases, a PSF is estimated and applied to all of the pixels or to a subset of the pixels without using the measured PSF from each aperture, for example, by defining an average expected PSF and applying it to all of the pixels.

The applied set of weights to the pixels may not have a one to one correspondence with the measured PSF for a given signal source. In some cases, for example, a set of PSFs determined on one array of apertures (a calibration array) will be used to define the set of PSFs to be applied to signals measured on one or more subsequent sample analysis arrays. Generally, these measured PSFs can be used to take into account differences in the image intensity from the design of the array and from the optical system, but will not compensate for array to array differences. The PSFs determined using a calibration array can be obtained either in trans-illumination mode, or using illumination from below the aperture array and measurement of emission from the apertures. Using signals obtained either before or during the reaction, a software mask is defined for each detector. In each software mask, a region of X by Y pixels is identified as corresponding to a given signal source. Within that X by Y region, each pixel is provided a weight that corresponds to the expected probability of a photon hitting that pixel from that signal source. This set of weights corresponds to the shape of the expected image of the signal source on that detector. The combination of these weighted X by Y regions defines a software mask. The X by Y region can be fixed across all of the signal sources and detectors or it can be allowed to vary. In some cases, the apertures or ZMWs are arranged in a regular pattern on the substrate such the number of pixels in each X by Y region on each detector comprises the same number of pixels (i.e. X and Y are fixed). In other cases, either due to regions of different spacing, ZMW's of different optical characteristics, or differences in the magnification or distortion in different parts of the optical system, the number of pixels in each of the X by Y regions on each of the detectors can vary. The X by Y region can have any suitable number of pixels, for example about 9, 12, 15, 16, 20, 25, 30, 36, 42, 49, 56, 64, 72, 81, 90, 100, 110 or more. The X by Y region can have, for example, between about 9 and 1000 pixels; or between 9 and 100 pixels, or between 9 and 64 pixels. Where the number of pixels is made small, the image resolution for each of the signal sources goes down, which can limit the precision of the software mask for noise reduction. Where the number of pixels becomes larger, more of the detector is taken up by each signal source, limiting the total number of signal sources that can be observed for a given detector. Thus it will be understood that the optimal number of pixels in the X by Y region can depend on the specifics of the analysis. We have found that an X by Y region of between about 9 to about 64 pixels is useful for some single molecule sequencing applications.

The term “each” is used in the application to indicate an individual item such as an individual pixel, or an individual X by Y region of pixels, and is not to be interpreted as requiring all of those individual items. For example, when it is stated that the signal from each pixel in an X by Y region is combined, it is not required that every single pixel be combined. For example, there may be some pixels within the X by Y region that have been determined upon calibration to be non-functional, such that the signal from these pixels would not be included.

In some cases, a set of PSFs for each aperture is determined on the same array that used for sequencing. Determining the PSF for each aperture on the same array that is used for sequencing has the advantage that the measured PSF includes array to array variations, ensuring that the applied PSF is as close as possible to the intensity probability for each aperture in the array. This set of PSFs can be measured either before or during the initiation of a sequencing reaction. As with defining the PSF on a calibration array, either trans-illumination or emission measurements can be used. Where the PSF is defined during the sequencing reaction, generally only emission measurements are used. In some cases, both a calibration PSF and a PSF defined on the analysis chip is used to define the PSF to apply to each aperture on that analysis chip. For this process, the calibration PSF provides a baseline PSF that is used to process the signals when the sequencing reaction begins. As the sequencing reaction is occurring, measurements are performed which provide the basis for updating and modifying the calibration PSFs. This process ensures that an optimum PSF is applied throughout the sequencing run, and can be used to compensate for drift in the system. Updating the PSF during the sequencing run can provide for a high quality PSF throughout the reaction, but it requires more processing resources than for the case where a single PSF is applied throughout the sequencing run. Updating the PSF generally requires averaging over a period of time during the sequencing reaction in order to obtain high enough signal to noise to reliably define the PSF. To obtain this signal, either the signal data can be concurrently sent to two different proceeding units, one for obtaining sequencing information, the other for obtaining information for defining the PSF. Alternatively, time multiplexing can be used to send the signal for some periods of time for sequence analysis, and other periods of time for defining the PSF.

The various X by Y region across a detector and between multiple detectors can include the same number of pixels, or can be varied to have different numbers for different X by Y regions. In some cases all of the X by Y regions on one detector or on all of the D detectors have the same number of pixels.

In certain additional cases, the variance of the pixel signal intensity for a given camera is also determined. Generally for CCDs this relationship is predictable and measurable being governed by the Shot noise on the detected photons and the CCD read-noise, as well as variances from the gain register for, e.g., EMCCDs. These CCD parameters are typically estimated from the calibration data using static signal data taken at different intensities, but they can also be measured from stable pixels (pulse free) in a sequencing movie. Using the PSF estimate and the signal-variance relationship the CCD pixels are weighted-summed by their inverse variance to maximize the SNR in the collapsed spectrum.

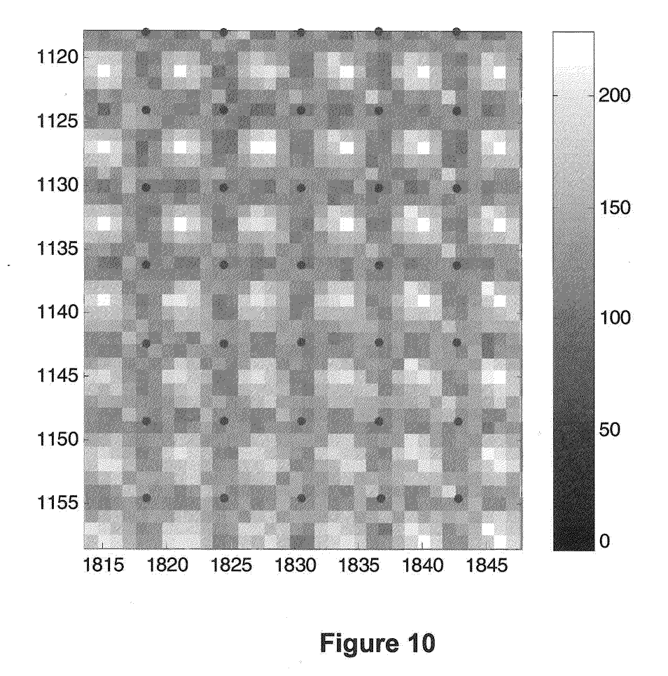

FIG. 10 shows an example of a portion of an image of an array of ZMWs obtained in trans-illumination mode. In the portion of the image, the individual pixels can be seen, and the brighter the pixel, the higher the intensity of light was detected at that pixel. The image of each individual ZMW is contained within a region of about 6.4 by 6.4 pixels. The pixel intensities measured at each pixel within each of the 6.4 by 6.4 region of pixels can be used to determine a PSF and a software mask to be applied to the output from the pixels while detecting emission from a ZMW array during an analytical reaction such as a sequencing reaction. Generally other information including estimates of background fluorescence are combined with the PSF information from an image like that of FIG. 10 in order to produce the software mask.

### 2. Color Calibration/Spectral Matrix

During the calibration process, the system is also calibrated for the image spectra from each source. In particular, in a sequencing reaction, signals associated with each of the different incorporated bases have a distinguishable spectrum. The color calibration procedure results in the production of a spectral matrix that can be used to combine the signals from all of the detectors in order to spectrally identify the presence of a labeled base.

During spectral calibration, the ZMW array is provided with a standard reference label that may include each pure dye, a pure labeled nucleotide, or another relevant pure component, e.g., a polymerase/template/primer complexed labeled nucleotide.

In addition, due to potential distortions in the optics (e.g. coma, chromatic and spherical aberration) one may also obtain calibration spectra across the field of view of the chip. In this way, a unique spectrum is used from the calibration data for a ZMWs position; thereby accounting for spatially dependent effects that may arise from the optics.

### 3. Noise/Pixel Variance

An important aspect of defining the software mask is understanding the noise relating to the pixels and the pixel variance (See step 758 of FIG. 7). These noise calibrations are generally performed on each of the D cameras in the analytical system. A first calibration involves a Dark Frames correction. This process involves averaging the signal over a number of closed shutter frames. The process is useful for 1) establishing any bias in the detector across the pixels, 2) removing 2-D structure from the detector itself in order to apply an image or scalar correction, and 3) for locating pixels with unexpectedly high dark current which can be masked in later analyses. A second calibration process that is sometimes employed is the definition of a Read Noise Map in which a time-series dark image of a few 1000 frames is obtained. From this, the sdev of each pixel gives an estimate of its read-noise. We have found that in some cases, this Read Noise for each pixel is reproducible and has a long-tail distribution. Since Read Noise can in some cases dominate the noise budget at the limits of optical detection, we can take advantage of this calibrated Read Noise map in defining the software mask pixel weights. Another optional calibration step for each of the detectors is a Flat Field correction. This calibration process is performed by illuminating the detectors with a flood illumination over the whole detector. This calibration can be used to normalize the image across the field of view, and in particular to normalize the response on smaller spatial scales. This process is also used for determining maps of dead pixels, or unresponsive columns or rows which can be given zero weight in the analysis of optical signals. The noise model that is employed in defining the software mask can use these pixel gain correction factors when calculating weights. In addition, it can also be useful to establish a gain relationship for each of the detectors. This gain measurement can be done in some cases using a flat field source. In other cases, the gain can be done in trans-illumination mode or using label excitation using one or more substrate arrays. In some cases the gain can be estimated during a sequencing run. Generally, for an EMCCD, there are two gain factors, the electron multiplication gain, which in some cases is subject to drift, and the photoelectron/count conversion or ADU gain. For a CMOS detector, only the second gain factor applies. These gain factors can be solved for using time series of a static source. The slope of the pixel signals vs. their variance in time can be used to establish counts to photoelectron gain conversion factors. With this the Shot noise can be estimated for any pixel intensity measured in counts and in combination with the pixel read-noise the total pixel variance can be calculated and therefore used in the optimal weighting scheme described. For some types of sensor, e.g. and EMCCD this variance estimate may additionally contain the multiplication noise.

In some cases, an overall system noise calibration step may be performed in the absence of any fluorescent or other labeling components within the ZMWs in the array, to ascertain and calibrate for noise that derives from the system as a whole, e.g., auto-fluorescence of the optical train components, the array substrate, etc. Typically, these noise sources will be factored into one or more of the filtering steps in an overall process, e.g., subtracted from overall signal levels, or in one of the other calibration steps, e.g., in identification of the image locations and/or generation of the spectral template.

### 4. Reaction Noise

The system is also typically calibrated for additional noise sources deriving from the reaction itself, e.g., resulting from nonspecific adsorption of dyes within an observation volume, presence of multiple complexes, and the like, as shown at step 760 of FIG. 7.

### B. Signal Extraction to Traces

Images or movies of signal data deriving from an actual sequencing reaction is processed initially based upon the calibration of the system, as set forth above. In particular, signal data is associated with a particular signal source, e.g., ZMW, in the array based upon the software mask defined during the calibration process. The result of the calibration process, above, is a time series of spectra from each of the four detectors for each ZMW, which can be stored as an image. The next step is to identify and classify pulse spectra from this image. Since the spectral matrix for experimentally represented dyes for each ZMW are known through the above calibration process, these images can be converted to time series signals (one for each dye).

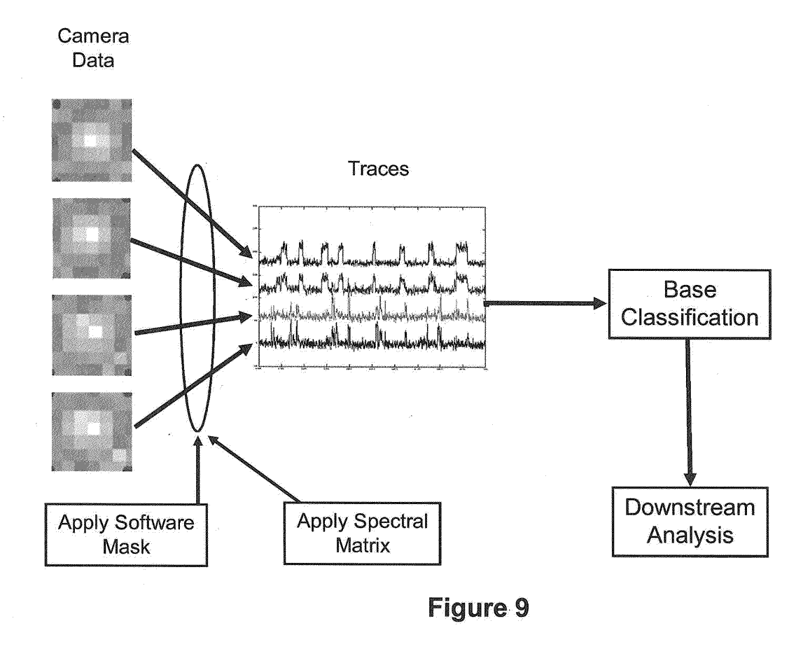

The signals for each ZMW are compared to the spectral template and for each located signal source, each spectral component is then collapsed into an individual trace. In particular, the signal intensity at the image location that corresponds to a particular spectral signal from a particular signal source is plotted and/or monitored as a function of time, to provide a time resolved trace of signal activity of a given color for a given ZMW. As a result, for each located ZMW using a four color sequencing process, four different traces will be generated that reflect the intensity of the different signal components over time. An example of trace data from four spectral traces from a single ZMW is shown in FIG. 9.

As noted above, the signal data represented in each trace is an aggregate signal of the particular pixels associated with a given spectral component of the signal. In particular, an image location may include a plurality of pixels in the detector, each pixel signal combined with the other pixel signals according to the weight defined by the software mask. in order to yield the most accurate data. rather than process signal data from each pixel in the image, the overall image can be aggregated and processed as a single data unit. In addition, the 2-dimensional software mask ensures that when the pixel signal data is combined, the signal to noise of the signal is optimized by obtaining the most signal from the most relevant pixels. While the software mask is described in terms of a 2 dimensional mask, in some cases the software mask can have 3, 4, or more dimensions. For example, in some embodiments, the software mask can comprise a time component. A time component can be used, for example, when the signals which are being measured have a well defined peak shape. The pixel weighting factors can be applied as a function of time to best define the shape of the peak over time.

In certain embodiments, optimal estimation of photon flux is performed using the following:

$${χ}_{kl}^{2} = {\sum }_{i , j} \frac{{( {Φ}_{kl} {P}_{ijkl} - {R}_{ij} )}^{2}}{{V}_{ij}}$$

The pixel response, represented by Rᵢⱼ, is an estimate of the number of photons incident on pixel i in camera j. The model point spread function (PSF) is represented by Pᵢⱼₖₗ is used to estimate the photon flux, represented by Φₖₗ which is the number of photons emitted by dye k from hole l. Such estimation is accomplished by minimizing “chi-square” (model fit vs. observed data), as follows:

$${[ \frac{\partial {χ}_{kl}^{2}}{\partial {Φ}_{kl}} ]}_{{Φ}_{ kl} = {F}_{kl}} = 0$$

A spatial sum can be computed to provide an estimate of the number of photons emitted from ZMW l and detected in camera j (Gⱼₗ) using the following:

$${G}_{jl} = {\sum }_{i} {y}_{ijl} \frac{{R}_{ij}}{{Q}_{ijl}}$$

A spectral sum can be computed to provide photon flux estimate F, which is an estimate of the number of photons emitted from ZMW l by dye k using the following:

$${F}_{kl} = {\sum }_{j} {x}_{jkl} \frac{{G}_{jl}}{{S}_{jkl}}$$

### C. Pulse Recognition

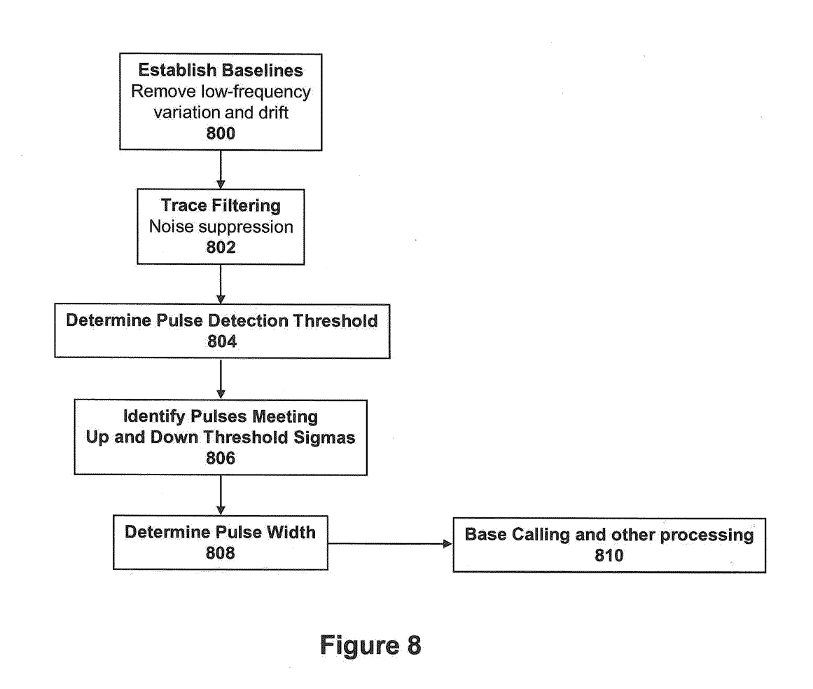

Once the traces have been generated for a given ZMW, they are subjected to the pulse recognition process. The pulse recognition process is schematically illustrated in the flow chart of FIG. 8. In the initial step 800, a baseline is established for the trace. Typically, the baseline may comprise signal contributions from a number of background sources (depending on the details of the spectral and trace extraction steps). For example, such noise will typically include, e.g., global (out-of-focus) background (e.g., auto-fluorescence and large scale spatial cross-talk from the optics) and diffusion (in focus) background from the individual ZMWs considered). These backgrounds are generally stable on the timescales of pulses, but still may vary slowly over longer timescales. Baseline removal comprises any number of techniques, ranging from, e.g.: a median of the trace, running lowest-percentile with bias correction, polynomial and/or exponential fits, or low-pass filtering with an FFT. Generally these methods will attempt to be robust to the presence of pulses in the trace and may actually be derived at through iterative methods that make multiple passes at identifying pulses and removing them from consideration of baseline estimation. In certain preferred embodiments, a baseline or background model is computed for each trace channel, e.g., to set the scale for threshold-based event detection.

Other baselining functions include correction for drift or decay of overall signal levels. For example, photobleaching of organic material sometimes present on the back of the ZMW array is believed to cause decay in the level of background, and thus result in a decreasing baseline over time. This same global background decay is present on portions of the substrate at which there is no ZMW, thus allowing the traces derived from these locations to be used in combination with the two dimensional global background image to estimate the contribution of this signal to every trace/channel across the chip. This component of variability can then be subtracted from each trace and is usually very effective at removing this decay. Typically, this is carried out prior to the baselining processes described above.

As shown, each trace's baseline is established at step 800. Following establishment of the baseline the traces are subjected to noise suppression filtering to maximize pulse detection (step 802). In particularly preferred aspects, the noise filter is a ‘matched filter’ that has the width and shape of the pulse of interest. While pulse timescales (and thus, pulse widths) are expected to vary among different dye labeled nucleotides, the preferred filters will typically look for pulses that have a general “top-hat” shape with varying overall duration. As such, a boxcar filter that looks for a pulse of prolonged duration, e.g., from about 10 ms to 100 or more ms, provides a suitable filter. This filtering is generally performed in the time-domain through convolution or low-pass frequency domain filtering. Other filtering techniques include: median filtering (which has the additional effect of removing short timescale pulses completely from the trace depending on the timescale used), and Savitsky-Golay filtering which tends to preserve the shape of the pulse—again depending on the parameters used in the filter).

Although described in terms of a generic filtering process across the various traces, it will be appreciated that different pulses may have different characteristics, and thus may be subjected to trace specific filtering protocols. For example, in some cases, a given dye labeled analog (e.g., A) may have a different pulse duration for an incorporation event than another different dye labeled analog (e.g., T). As such, the filtering process for the spectral trace corresponding to the A analog will have different filtering metrics on the longer duration pulses, than for the trace corresponding to the T analog incorporation. In general, such filters (e.g., multi-scale filters) enhance the signal-to-noise ratio for enhanced detection sensitivity. Even within the same channel there maybe a range of pulse widths. Therefore typically a bank of these filters is used in order to maximize sensitivity to pulses at a range of timescales within the same channel.

In identifying pulses on a filtered trace, a number of different criteria may be used. For example, one could use absolute pulse height, either with or without normalization. Alternatively, one could identify pulses from the pulse to diffusion background ratio as a metric for identifying the pulse. In still other methods, one may use statistical significance tests to identify likely pulses over the background noise levels that exist in a given analysis. The latter method is particularly preferred as it allows for variation in potential pulse intensities, and reduces the level of false positives called from noise in the baseline.

As noted previously, a number of signal parameters may be and generally are used in pulse identification (as well as in pulse classification). For purposes of illustration, however, the process illustrate in the flow chart of FIG. 8 focuses primarily on the use of two main pulse metrics, namely pulse intensity and pulse width. As will be appreciated, the process steps at step 806 and 808 may generally include any one or more of the various pulse metric comparisons set forth elsewhere herein.

As such, following filtering, standard deviation of the baselines (noise and pulses) and determination of pulse detection thresholds are carried out at step 804. Preferred methods for determining the standard deviation of a trace include robust standard deviation determinations including, e.g., being based upon the median absolute difference about the baseline, a Gaussian or Poisson fit to the histogram of baselined intensities, or an iterative sigma-clip estimate in which extreme outliers are excluded. Once determined for each trace, a pulse is identified if it exceeds some preset number of standard deviations from the baseline, at step 806. The number of standard deviations that constitute a significant pulse may vary depending upon a number of factors, including, for example, the desired degree of confidence in identification or classification of significant pulses, the signal to noise ratio for the system, the amount of other noise contributions to the system, and the like. In a particularly preferred aspect, the up-threshold for an incorporation event, e.g., at the initiation of a pulse in the trace, is set at about 5 standard deviations or greater, while the down-threshold (the point at which the pulse is determined to have ended) is set at 1.25 standard deviations. The pulse width is then determined from the time between the up and down thresholds at step 810. Once significant pulses are initially identified, they are subjected to further processing to determine whether the pulse can be called as a particular base incorporation event at step 812, and as described in greater detail, below.

In some cases, multiple passes are made through traces examining pulses at different timescales, from which a list of non-redundant pulses detected at such different time thresholds may be created. This typically includes analysis of unfiltered traces in order to minimize potential pulse overlap in time, thereby maximizing sensitivity to pulses with width at or near the highest frame rate of the camera. This allows the application of pulse shape or other metrics to pulses that inherently operate on different timescale. In particular, an analysis at longer timescales may establish trends not identifiable at shorter timescales, for example, identifying multiple short timescale pulses actually correspond to a single longer, discrete pulse.

In addition, some pulses may be removed from consideration/evaluation, where they may have been identified as the result of systematic errors, such as through spatial cross-talk of adjacent ZMWs, or spectral cross-talk between detection channels for a given ZMW (to the extent such issues have not been resolved in the calibration processes, supra). Typically, the calibration process will identify spectral and spatial cross-talk coefficients for each ZMW, and thus allow such components to be corrected.

Pulse recognition, e.g., on the one dimensional traces, as described above, may provide sufficient distinction to classify pulses as corresponding to particular dyes, and consequently, particular bases, based purely on their peak height. In most preferred aspects, however, the pulses identified for each ZMW are used to return to the ZMW's spectra to extract individual ZMW's spectra for each pulse for additional pulse metrics and to identify any interfering signal components, such as, whether a detected pulse in a trace is due to spectral cross-talk.

In certain embodiments, a trace-file comprises D-dye-weighted-sum (DWS) traces, where trace is optimized to have maximum pulse detection sensitivity to an individual dye in the reaction mixture. This is not a deconvolved or multicomponent trace representation, and suffers from spectral cross-talk. The classification of pulses to individual dyes is described below.

### D. Pulse Spectrum Extraction and Classification

Classification of an extracted pulse into one of the 4 (or N) consistuent dyes) is, then carried out by comparing the extracted spectrum to the spectra of the standard dye sets established in the calibration process. A number of comparative methods may be used to generate a comparative metric for this process. For example, in preferred aspects, a χ² test is used to establish the goodness of fit of the comparison. In a particular example, for an extracted pulse spectrum (Sᵢ), the amplitude (A) of the fit of an individual dye-spectral shape; as measured from the pure dye calibration spectrum, Pᵢ, is the only variable to solve and will have a χ² value of:

$${χ}^{2} = {\sum }_{i} \frac{{( {S}_{i} - {AP}_{i} )}^{2}}{{V}_{i}}$$

The probability that the pure dye spectrum fits with the extracted spectrum is then derived from the χ² probability distribution (with a number of degrees of freedom for the number of data points used, υ).

The classification of a given pulse spectrum is, then identified based upon calculating, values for each of the four different dyes. The lowest χ² value (and the highest probability fit), assigns the pulse to that particular dye spectrum, and the pulse is called as corresponding to that dye.

Again, other techniques may be employed in classifying a pulse to a particular spectrum, including for example, measuring correlation coefficients for each of the 4 possible dyes for the spectrum, with the highest correlation providing the indication to which base or dye the pulse will be classified.

In addition to comparison of the pulse spectra to the calibration spectra, a number of other pulse metrics may be employed in addition to a straight spectral comparison in classifying a pulse as correlating to a given dye/nucleotide. In particular, in addition to the spectral properties associated with a given dye, signals associated with incorporation of a given dye labeled nucleotide typically have a number of other characteristics that can be used in further confirming a given pulse classification. For example, and as alluded to above, different dye labeled nucleotides may have different characteristics such as pulse arrival time (following a prior pulse), pulse width, signal intensity or integrated counts (also referred to as pulse area), signal to noise ratio, power to noise ratio, pulse to diffusion ratio (ratio of pulse signal to the diffusion background signal in each ZMW), spectral fit (e.g., using a minimum χ² test, or the like), spectrum centroid, correlation coefficient against a pulse's classified dye, time interval to end of preceding pulse, time interval to the ensuing pulse, pulse shape, polarization of the pulse, and the like.

In particularly preferred aspects, a plurality of these various pulse metrics are used in addition to the spectral comparison, in classifying a pulse to a given dye, with particularly preferred processes comparing two, three, five, 10 or more different pulse metrics in classifying a pulse to a particular dye/nucleotide.

In certain preferred embodiments, a conditional random field (CRF) model is used to segment and label pulse regions using the following equation:

$${P}_{\vec{w}} ( \vec{s} \vert \vec{w} ) = \frac{exp ( {\vec{w}}^{T} F ( \vec{x} , \vec{s} ) )}{{Z}_{\vec{x}}}$$

This serves to maximize the conditional probability of the labeling given the experimental data. Features typically used in the CRF include, e.g., the presence of a signal or “existence,” the base identity, and the duration or kinetics of the pulse. The CRF is typically trained on simulated data, but can also be trained on actual data, e.g., collected using a known template sequence. In general, CRF algorithms provide a basis for estimating the likelihood of alternative predictions based on various factors other than simple statistics to provide a measure of the quality or likelihood of a particular call given the observed pulse features, e.g., over a set of data, for a given position, e.g., from multiple reads of the same or identical template sequences.

### E. Base Calling

Once the pulse spectrum is classified as corresponding to a particular dye spectrum, that correlation is then used to assign a base classification to the pulse. As noted above, the base classification or “calling” may be configured to identify directly the dye labeled base added to the extended primer sequence in the reaction, or it may be set to call the complementary base to that added (and for which the pulse spectrum best matches the dye spectrum). In either case, the output will be the assignment of a base classification to each recognized and classified pulse. For example, a base classification may be assignment of a particular base to the pulse, or identification of the pulse as an insertion or deletion event, as described in more detail below.

In an ideal situation, once a pulse is identified as significant and its spectrum is definitively identified, a base could simply be called on the basis of that information. However, as noted above, in typical sequencing runs, signal traces include a substantial amount of signal noise, such as missing pulses (e.g., points at which no pulse was found to be significant, but that correspond to an incorporation event) false positive pulses, e.g., resulting from nonspecifically adsorbed analogs or dyes, or the like. Accordingly, pulse classification (also termed base classification) can in many cases involve a more complex analysis. As with pulse identification, above, base classification typically relies upon a plurality of different signal characteristics in assigning a base to a particular identified significant pulse. In many cases, two, three, five, ten or more different signal characteristics may be compared in order to call a base from a given significant pulse. Such characteristics include those used in identifying significant pulses as described above, such as pulse width or derivative thereof (e.g., smooth pulse width estimate, cognate residence time, or non-cognate residence time), pulse intensity, pulse channel, estimated average brightness of pulse, median brightness of all pulses in the trace corresponding to the same channel (e.g., same color and/or frequency), background and/or baseline level of channel matching pulse identity, signal to noise ratio (e.g., signal to noise ratio of pulses in matching channel, and/or signal to noise ratio of each different channel), power to noise ratio, integrated counts in pulse peak, maximum signal value across pulse, pulse density over time (e.g., over at least about 1, 2, 5, 10, 15, 20, or 30 second window), shape of and distance/time to neighboring pulses (e.g., interpulse distance), channel of neighboring pulses (e.g., channel of previous 1, 2, 3, or 4 pulses and/or channel of following 1, 2, 3, or 4 pulses), similarity of pulse channel to the channel of one or more neighboring pulses, signal to noise ratio for neighboring pulses; spectral signature of the pulse, pulse centroid location, and the like, and combinations thereof. Typically, such comparison will be based upon standard pattern recognition of the metrics used as compared to patterns of known base classifications, yielding base calls for the closest pattern fit between the significant pulse and the pattern of the standard base profile.

Comparison of pulse metrics against representative metrics from pulses associated with a known base identity will typically employ predictive or machine learning processes. In particular, a “training” database of “N previously solved cases” is created that includes the various metrics set forth above. For example, a vector of features is analyzed for each pulse, and values for those features are measured and used to determine the classification for the pulse, e.g., an event corresponding to the pulse, e.g., an incorporation, deletion, or insertion event. As used herein, an incorporation event refers to an incorporation of a nucleotide complementary to a template strand, a deletion event corresponds to a missing pulse resulting in a one position gap in the observed sequence read, and an insertion event corresponds to an extra pulse resulting in detection of a base in the absence of incorporation. For example, an extra pulse can be detected when a polymerase binds a cognate or noncognate nucleotide but the nucleotide is released without incorporation into a growing polynucleotide strand. From that database, a learning procedure is applied to the data in order to extract a predicting function from the data. A wide variety of learning procedures are known in the art and are readily applicable to the database of pulse metrics. These include, for example, linear/logistic regression algorithms, neural networks, kernel methods, decision trees, multivariate splines (MARS), multiple additive regression trees (MART™), support vector machines.

In addition to calling bases at pulses identified as significant, the present methods also allow for modeling missing pulses. For example, conditional random fields (CRF) are probabilistic models that can be used to in pulse classification (see, e.g., Lafferty, et al. (2001) Proc. Intl. Conf. on Machine Learning 01, pgs 282-289, incorporated herein by reference in its entirety for all purposes). A CRF can also be conceptualized as a generalized Hidden Markov Model (HMM), some examples of which are described elsewhere herein and are well known in the art. As described further below, the present invention includes the use of CRFs to model missing bases in an observed pulse trace.

Further, employing machine learned meta-algorithms for performing supervised learning, or “boosting” may be applied to any of the foregoing processes or any combinations of those. Briefly, such boosting incrementally adds to the current learned function. At every stage, a weak learner (i.e., one that yields an accuracy only slightly greater than chance) is trained with data, and that output is added to the learned function with some strength (proportional to how accurate the weak learner is. The data is then reweighted. Identifications that the current learned function has missed are then boosted in importance so that subsequent weak learners may be applied to attempt to correct the errors. Examples of boosting algorithms include, for example, AdaBoost, LPBoost, TotalBoost, and the like. For example, in certain embodiments gradient boosting is employed in which additive regression models are constructed by sequentially fitting a simple parameterized function (base learner) to current “pseudo”-residuals by least-squares at each iteration (see, e.g., Friedman, J. H. (1999) “Stochastic gradient boosting,” Computational Statistics and Data Analysis 38:367-378; and Friedman, J. H. (2000) “Greedy function approximation: a gradient boosting machine,” Annals of Statistics 29:1189-1232, both of which are incorporated herein by reference in their entireties for all purposes).

As will be appreciated, and as alluded to previously, assignment or classification of a particular pulse as incorporation of a particular base, e.g., employing the processes above, will typically be based, at least partially, on a desired probability score, e.g., probability that the called base is accurate. As noted, the probability scores for base calling, like PHRED scores for base calling in chromatographically identified bases, will typically take into account the closeness of fit of a pattern of signal metrics to a standard signal profile, based upon a plurality of different signal characteristics that include those elements described elsewhere herein, including the signal environment around a given pulse being called as a particular base, including adjacent pulses (e.g., pulse channel, density of pulses, spectral signature, centroid location, interpulse distances), adjacent called bases (e.g., identity of base, similarity of pulse channel to the channel of one or more neighboring pulses), signal background levels, pulse shape (height or intensity (brightness), width or duration, integrated counts in peak, maximum signal value, etc.), signal to noise ratios, power to noise ratios, and other signal contributors, and combinations thereof. Typically, preferred base calls will be made at greater than the 90% probability level (90% probability that the called base is correct), based upon the probability evaluation, preferably, greater than 95% probability level, more preferably greater than 99% probability, and even more preferably, greater than 99.9% or even 99.99% probability level.

The processes of the invention will typically be integrated with sequence arrangement processes for arranging and outputting the individual called bases into a linear sequence, and outputting such data to the user in any of a variety of convenient formats. Additionally, such processes will optionally verify and correct such sequence data based upon iterative sequencing of a given template, multiple sampling of overall sequence fragments through the sequencing of overlapping templates, and the like, to provide higher confidence in sequence data obtained.

In certain embodiments, a binary classifier (e.g., a boosted classification and regression tree (CART) classifier) is used to label each significant pulse detected in a pulse trace as an enzymatic incorporation or a spurious insertion. The classifier has access to not only the pulse metrics for a specific pulse under consideration, but also the features (e.g., metrics, etc.) of the surrounding pulses. The metrics can be chosen by the ordinary practitioner based upon the experimental system being used, and for sequencing by incorporation reactions such metrics can include, e.g., detected channels, total signals, durations (e.g., cognate or non-cognate residence times), interpulse durations, spectral fit qualities, various derived functions of these metrics, as well as other metrics described herein. A training test for the classifier is created by aligning a pulse list (essentially a chronological list of the pulses identified in a pulse trace) to a known template sequence. Pulses marked as insertions or incorporations are included in the training set, and are so identified. Pulses aligned as mismatches are not included in the training set. The alignment and classifier training steps are iterated to improve the quality of the alignment and the accuracy of the classifier. The classifier makes decisions on the basis of the metrics of the observed neighboring pulses, which reflect the true underlying template, but may be obscured by sequencing errors near the base being classified, preventing the classifier from accurately inferring the template context. An alternate approach is to track the template context as a state variable in a Markovian sequential classifier such as an HMM or a CRF, as described further below.

In further embodiments, a boosted CART classifier is used to refine (e.g., by iterative gradient boosting) an asynchronous CRF alignment from a training set of pulse trace data and the known nucleotide sequence of the template used to generate the training set. The CRF aligner (a probabilistic sequence alignment model) is iteratively refined or “trained” using the boosted CART classification method to generate a trained CRF aligner that is sensitive to the vector of features chosen by the user as relevant to the determination of whether a significant pulse corresponds to an incorporated base or an insertion, and also to identify positions at which a base was incorporated but no significant pulse was identified. For example, the vector of features can include metrics (e.g., pulse width or derivative thereof, pulse intensity, pulse channel, estimated average brightness of pulse, median brightness of all pulses in the trace corresponding to the same channel, background and/or baseline level of channel matching pulse identity, signal to noise ratio, power to noise ratio, integrated counts in pulse peak, maximum signal value across pulse, pulse density over time, shape of and distance/time to neighboring pulses, channel of neighboring pulses, similarity of pulse channel to the channel of one or more neighboring pulses, signal to noise ratio for neighboring pulses, spectral signature of the pulse, pulse centroid location, and the like) as well as extra “weight” parameters to specify which of the features are more highly predictive of the actual template sequence given the observed pulse trace. The model is trained by using gradient optimization to find the weight parameters that maximize or optimize the objective function, the objective function being the score of the correct template (the known training sequence used to generate the data) divided by the sum of the score for all templates. This transforms the score into a normalized probability distribution, and the probability for the correct known sequence is optimized by the method, as further described below.

During the training of the CRF alignment algorithm, a set of features is chosen as the vector of features determined for each significant pulse, and the training method generates scoring functions that map these features to scores in an alignment matrix, as described below. A training set of significant pulses in a pulse trace is aligned to a known template sequence to which it corresponds. At each position, the known base call is compared to the observed pulse metrics and a score is assigned or returned for each subsequent “move” in the alignment matrix, resulting in a set of scores across the matrix that typically includes a score for each event or “move” for every significant pulse in the observed trace. A positive score is typically assigned for a move that favors the correct path through the matrix based on the known template sequence (e.g., moves the current path nearer the correct path or maintains the correct path), and a negative score is typically assigned for a move that disfavors the correct path (e.g., moves the current path away from or no closer to the correct path). Since the training pulse traces are being compared to a known sequence, errors in the base calling of the pulse traces (e.g., miscalled bases, extra pulses, or missing pulses) are readily identified and used to refine the scores at each position based on the vector of features for each significant pulse. Iteration of the refinement process results in a set of scoring functions based on a set of pulse features for each base call “event.” Typical base call events are 1) an insertion at a position complementary to an A in the template sequence; 2) an insertion at a position complementary to a C in the template sequence; 3) an insertion at a position complementary to a G in the template sequence; 4) an insertion at a position complementary to a T in the template sequence; 5) a deletion at a position complementary to an A in the template sequence; 6) a deletion at a position complementary to a C in the template sequence; 7) a deletion at a position complementary to an G in the template sequence; 8) a deletion at a position complementary to a T in the template sequence; 9) an incorporation of a complementary base at a position complementary to an A in the template sequence; 10) an incorporation of a complementary base at a position complementary to an C in the template sequence; 11) an incorporation of a complementary base at a position complementary to an G in the template sequence; and 12) an incorporation of a complementary base at a position complementary to an T in the template sequence, where a deletion refers to a missing significant pulse and an insertion refers to an extra significant pulse, as described above. As such, the scores for each event depend not only on whether the event was a match or a mismatch event, but also on the values for the set of features for each pulse in the trace. For example, the “incorporation of a complementary base at a position complementary to an A in the template sequence” (IncA) function is trained based on iteratively testing it on all the different incidences of this event in the alignment matrix. Since the template is known the resulting algorithm can be improved by refining the scoring functions to return a higher gradient from the same template and trace data. After one or more iterations of the gradient boosting method, the resulting scoring functions are effectively customized to accurately identify particular events in additional pulse traces, e.g., those generated using a template of unknown sequence. Such analyses are used, e.g., to facilitate accurate determination of the template sequence, as described further below.

In certain embodiments, once the CRF aligner has been trained using a known template and corresponding pulse trace data, the algorithm can be used to classify pulses (e.g., base calling and insertion and deletion identification) for pulse trace data for which the template sequence may or may not be known using the scoring functions determined in the iterative training of the CRF aligner (and now preferably fixed). The boosted CART classifier uses the relative influences (weights) of the various features associated with each pulse (e.g., the scoring functions) to inform on the CRF aligner. After aligning an observed pulse trace with a known or predicted template sequence, a score is returned for each move through the CRF alignment matrix for each pulse in the trace, and the value of the score is based on the scoring functions determined in the CRF training method. The best path through the alignment matrix is identified as that path for which the sum of the scores is highest (the Viterbi path) and this path is used to classify various positions (e.g., the pulses and interpulse regions) in the trace, e.g., as a particular base, a deletion, or an insertion. In certain embodiments, the best scoring template is determined using the “forward algorithm,” which computes the sum of the scores of all possible paths for that template. Then the Viterbi path is determined and used to label the various events in the trace, e.g., insertions, deletions, etc. (In the training phase the forward algorithm is optimized using the known template sequence.) In some embodiments, significant pulses in a single pulse trace are classified based on a known template sequence. In other embodiments, significant pulses in multiple pulse traces generated for a single unknown template are classified, e.g. by aligning a predicted template sequence to each pulse trace in a separate CRF alignment matrix. After each round of alignment, the scores and gradients generated are used to refine the predicted template sequence in an iterative fashion until a final “best” template sequence is determined and identified as the consensus sequence of the template. In this way, redundant sequence information can be used to determine a sequence of a nucleic acid of interest, whether generated from repeated sequencing of a single molecule comprising the nucleic acid, sequencing multiple identical molecules comprising the nucleic acid (e.g., after amplification), or a combination thereof (e.g., repeatedly sequencing multiple identical molecules comprising the nucleic acid). The initial predicted template sequence can be derived in a variety of ways. For example, it can be one of the original pulse traces, it can be derived from a simple consensus algorithm using two or more of the original pulse traces, it may be a sequence from a different sequencing methodology, it may be a homologous sequence from an organism other than that from which the template was isolated (e.g., a closely related species, or more distantly related where the sequence is highly conserved), etc. Although boosted CART classifiers are included in certain exemplary methods described herein, other boosted classifiers known in the art may be substituted.

A number of other filtering processes may be used in the overall evaluation of data from sequencing by incorporation reactions as discussed herein. For example, a number of filtering processes may be employed to identify signal sources or ZMWs that are yielding the highest quality level of data, e.g., resulting from a single fully functional polymerase/template/primer complex, immobilized on the bottom surface of the ZMW. These filters may rely upon a number of the metrics described above. Alternatively, these filters may employ holistic characteristics associated with a long time scale showing a large number of pulses, and determining whether the longer timescale metrics of the traces have characteristics of a typical sequence by incorporation trace, e.g., relatively regular, high confidence (based upon one or a number of relevant pulse metrics) pulses coming out over the course of the trace, yielding a “picket fence” appearance to the trace. Alternatively, additional components may be introduced to the reactants, e.g., labeling of the complexes, to facilitate their identification in the filtering process. As such, the existence of the indicator would be an initial filter to apply to any ZMW's data traces.

Although described in some detail for purposes of illustration, it will be readily appreciated that a number of variations known or appreciated by those of skill in the art may be practiced within the scope of present invention. To the extent not already expressly incorporated herein, all published references and patent documents referred to in this disclosure are incorporated herein by reference in their entirety for all purposes.

### Further Example Embodiment

In order to further illustrate the invention, details are provided below regarding data collection and data analysis related to particular example sequencing systems. The details below are provided as a further example of embodiments of the invention and should not be taken to limit the invention. In some sequencing systems of interest, the relative weakness of detected signals, the levels of noise, the very small feature sizes of the reaction locations, and the speed and variation of the incorporation reaction, present challenges for signal data analysis and base-calling. These challenges are addressed by a number of novel data analysis methods and systems according to specific embodiments of the invention.

Example of Raw Data from an Array of Reaction Locations

In order to better illustrates aspects of particular embodiments of the invention, characteristics of an example set of captured data are briefly described. A particular example system of the type illustrated in FIG. 5 can be further understood as follows. Substrate 102 is an ordered arrangement (e.g., an array) of reaction locations and/or reaction wells and/or optical confinements and/or reaction optical sources and/or apertures 104. Detectors/cameras 161-164 comprise ordered arrays of optical signal collectors or detectors, such as CMOS, CCD, EMCCD, or other devices able to detect optical signals and report intensity values. Such devices are well understood in the art and typically are known as able to detect light intensity incident on the detector during a given time interval (or frame) and able to output a numerical intensity value representative of the light intensity collected during a particular interval. Detectors 161-164 will typically include an array of addressable areas, each able to make an intensity measure and data output. The separate areas are commonly referred to as pixels. Each pixel generally has an address or coordinate (e.g., x, y) and outputs one or more intensity levels for a given interval or frame. Pixels that output only one intensity level are sometimes referred to as gray-scale or monochrome pixels. A static pixel array of light intensity values (e.g., generally for one interval) is commonly referred to as an image or frame. A time sequence of frames is referred to as a movie.

Detectors/Cameras such as 161-164 may be capable of only the most basic functions necessary to capture and output intensity levels. Alternatively, the detectors/cameras such as 161-164 may include or be associated with logic circuitry able to perform various optical adjustments and/or data collection and/or data manipulation functions such as adjusting frame rate, correcting for noise and/or background, adjusting alignment or performing tracking, adjusting pixel size, combining indicated pixels prior to output, ignoring or filtering indicated pixels, etc. Thus, the raw data available from a detector 161-164 typically can be understood as a sequence of 2-dimensional arrays of pixel values at a particular frame rate. In an example system as in FIG. 5, the raw pixel data from each of the detectors mono-chrome. In specific embodiments of the present invention, the detectors 161-164 capture and output 1 frame each 10 milliseconds (or 100 frames per second (f.p.s.)).

Data from One Reaction Location/Optical Source

While the present invention is generally directed to collection of data from many optical sources in parallel, some aspects of the invention are better understood with reference to data captured from a single optical source. In specific embodiments, the optical signal (or light) from one location 102 will pass through an optical train including a collection tube lens, a collection relay lens, and a series of dichroic elements that direct different spectral components of the light emitted by the location 102 onto an X by Y region of pixels on each of the four detectors.

### Analysis of Arrays of Reaction Locations

In specific embodiments, data capture and data analysis according to the present invention includes many novel elements related to analyzing a large number of individual sequencing reactions located in an array of reaction locations or optical confinements. The invention, in specific embodiments, addresses the difficulties that arise in such a system and takes advantage of the unique properties of the data arising from such a system.

Analysis of sequencing-by-incorporation-reactions on an array of reaction locations according to specific embodiments of the invention is illustrated graphically in FIG. 9. In this summary figure, data captured by four cameras is represented as a movie. A software mask is applied to the data which has information from the calibration steps defining a centroid and a PSF for each ZMW. The spectral matrix which contains the spectral sensitivity for each camera is used to treat the data such that a pulse spectrum can be generated where the peaks for each color represent input from the combined detectors. The information from the weighted pixels for each ZMW is combined to provide a trace which represents the output from each camera weighted to take into account the expected contributions from each dye to each of the spectral channels corresponding to each camera. The traces are used to for base classification, and further downstream analysis.

### Calibrations

Typically, various adjustments or calibrations are made in digital imaging systems both prior to and during image capture. These adjustments can include such things as determining and correcting for background noise or various distortions caused by the optical and/or digital capture components, adjusting frame or shutter speed based on intensity levels, adjusting contrast in reported intensity levels, etc. Various such calibrations or adjustments may be made according to specific embodiments of the invention so long as the adjustments to not interfere with the data analysis as described below. Calibrations particular to specific embodiments of the present invention are described in more detail herein. Some of these calibration steps described herein may be performed periodically (such as once a week or once a day), other calibrations may be performed once at the beginning of a sequencing reaction data capture and analysis, and some calibrations are performed on a more continuous basis, throughout or at intervals during a reaction capture and analysis. These calibration steps can include such things as centroid determination, 2 dimensional PSF determination, alignment, gridding, drift correction, initial background subtraction, noise parameter adjustment, spectral calibration, frame-rate adjustment, etc.

### Gridding

An initial step in analyzing data from a system such as illustrated in FIG. 5 is determining which sets of pixels of detectors 561-564 correspond to individual reaction locations 504. (In some implementations, this step could be addressed in the construction of the system, so that detectors and reaction locations are manufactured to have a fixed association.) Gridding, in particular embodiments, is an initial identification of particular reaction locations with particular areas of pixels in an image. According to specific embodiments of the invention, imaged signals are correlated to the known spacing of image sources on the ZMW array. Optionally, one or more registration marks incorporated into the array can be used. For example, in preferred aspects, rows of ZMWs in an array will include one or more blank spaces in place of a ZMW, where the blanks will be spaced at regular, known intervals. Other registration marks might include regularly spaced image sources that are separate from the ZMWs, but are at known locations and spacing relative to the ZMWs in the array to permit alignment of image to the array. Such image sources may include apertures like ZMWs, or may include fluorescent or luminescent marks that provide a signal. Gridding in generally accomplished with an illuminated reference frame.

### Determining Individualized Sub-Pixel Reference Centroids

According to specific embodiments of the invention, after a initial association of pixel areas in each of the four cameras to with particular ZMWs (gridding), an individualized reference centroid is determined and stored for each or nearly each ZMW. This centroid can be determined by finding the geometric center from a variety of estimation techniques (e.g. intensity weighted or model fitting) center from a known spectrum, high SNR, narrow band light source that is imaged on detectors 561-564 of FIG. 5 through generally the same optical train as sequencing reaction optical signals. With reference to FIG. 5, the illumination is either directed through the partially transparent ZMWs 504, or the illumination is provided from below onto an array of ZMWs having a fluorescing species. The light from the ZMW's is detected through the collection optical train. Note that, while pixel address locations are generally integer values, formulas for determining a Gaussian center provide a decimal result. Using an accurate illumination through generally the exact optical path allows determination of a subpixel reference centroid by using a selected number of decimal positions from the subpixel center provide a decimal result. The reference sup-pixel centroid is stored for each ZMW for each detector and used as described further below. In specific embodiments, trans-illumination is provided by one or more light sources with narrow band-pass filters or by a series of narrow band light sources. In an example embodiment, the subpixel reference centroid is rounded to a closest 0.1 interval. This subpixel reference centroid on each camera, in the case of SF, defines the centre of the ROI of the ZMW.

### Determining Background Noise

Background noise is determined by a combination of measurement and estimation. The elements of background noise include one or more of: 1) Autofluorescence from the objective lens assembly, 2) chip or array autofluorescence, which can vary in intensity across the detector where the excitation source varies, 3), Trans-illumination fluorescence, in which a solution containing fluorophores acts as a light source similar to a trans-illumination source, 4) Diffusion background from fluorophores that are freely diffusing in solution, or 5) Spatial cross-talk resulting from fluorescence into the image of a ZMW from a neighboring ZMW.

### Pulse Recognition

One process for trace pulse recognition comprises the steps of 1) for each dye trace for a ZMW determine a baseline correction for the dye trace, 2) for each dye trace for a ZMW, detect and remove low-frequency baseline variation, 3) for each dye trace for a ZMW, apply noise reduction filters, optionally noise filters using individualized ZMW parameters, 4) for each dye trace for a ZMW, determine a standard deviation of baseline noise and use that to set pulse detection thresholds, 5) identify the start and end times of any significant pulse by comparing intensity values to pulse detection thresholds, and 6) for each dye trace for a ZMW, store significant pulse start and end times.

Further refinements to a pulse detection algorithm from that described above according to specific embodiments of the invention may be made by consideration of variability in captured spectral intensity data that is due solely to the expected kinetic behavior of the underlying sequencing reaction. Such data can, for example, include noiseless traces created by a kinetic model simulator.

Using the data as described above, a pulse detection algorithm according to specific embodiments of the invention, can assign confidence levels and make adjustments to account for stochastic false positive (FP) rates (e.g., detecting a pulse as a result of noise alone), stochastic false negative (FN) rates (e.g., failing to detect a pulse because it is masked by background noise), and miss-match (MM) errors (e.g., incorrectly classifying the spectra of a pulse due to its detected width and intensity.) Using such an analysis, for example, the invention can determine a pulse calling threshold, e.g. around 3.5-4.5 sigma for each channel based on the kinetic parameters of the incorporation reaction and the frame capture parameters.

### Pulse Recognition Using DBR (Diffusional Background Ratio)

As an alternative to pulse recognition using pulse intensity as the primary signal value as described above, according to further specific embodiments, the invention uses the ratio of pulse height to diffusion background, or DBR (diffusional background ratio) in determining significant pulses. While at times this may be referred to a component of SNR (signal to noise ratio), the term DBR is used to avoid confusion with more traditional usages of SNR. In specific embodiments, it has been found that calling pulses by intensity or by sigma can either fail due to laser intensity variations or due to background noise variations (respectively). Calling pulses by the DBR according to specific embodiments of the invention makes the “intensity” component of the pulse less variable even in the presence of laser excitation variations and regardless of background noise envelope fluctuations (due to concentration variations, extremely sticky ZMWs, etc). Furthermore, setting the pulse intensity threshold according to the intensity contributions of freely diffusing fluorophores in the ZMW provides a theoretical framework for locating a single molecule event in a ZMW and provides some immunity from other sources of signal variations and error. There are several methods of obtaining an estimate of the DBR intensity per ZMW.

Thus, in specific embodiments, pulse intensity is described not in absolute counts measured against a threshold, but as a ratio against the background diffusion of fluorophores in and above an individual ZMW.

According to specific embodiments of the invention, for any given pulse, define its DBR as: DBR=(Intensity−dcOffset)/(dcoffset−NDB) where (Intensity−dcOffset) is the average intensity of a pulse above baseline, and “NDB” is the portion of the baseline (dcOffset) that is not diffusion background (e.g., baseline from autofluorescence, base clamping, etc.). In particular embodiments, the NDB is determined from a sample movie of the array (or a neutral substrate, such as a solid aluminum film) with the same laser and camera conditions, which provides values for NDB(ZMW).

The DBR method of pulse calling provides additional information about where in the ZMW a particular pulse originated. This information is used in specific embodiments to determine if multiples polymerase are sequencing in a ZMW, in which case data from that specific ZMW may be excluded from further data analysis. The location of a fluorophore within a ZMW can also be used as one of the parameters in the data analysis as described herein.

The maximum values of the DBR of pulses from a single ZMW also allows estimation of the ZMWs effective diameter according to specific embodiments of the invention. In a particular example implementation, this method was used to estimate the ZMW diameters in an array to vary within 13 nm.

DBR thresholding in some embodiments may be vulnerable to diameter variations of the ZMWs themselves across the array (because more diffusion will occur into larger diameter ZMWs. In specific embodiments, this is accounted for on a per-ZMW basis, for example by transmission light analysis prior to sequencing.

### Trace or Reaction Location Rejection

According to specific embodiments of the invention, as described herein, analysis of individual ZMWs includes repeated evaluation of whether a ZMW should be excluded from further analysis. Because large numbers of reaction locations are being prepared and monitored, it is expected that in some systems some percentage of reaction locations will not provide useful data. This may occur if no reaction enzyme becomes located in a particular ZMW, if more than one reaction enzyme is located in a ZMW or if a reaction enzyme is otherwise producing problematic data. Rejection of particular reaction location data streams may be performed at multiple points during the analysis where the captured data does not match expected data criteria.

### Pulse Classification/Confirmation/Base Calling

An example of pulse classification, confirmation, and base calling comprises the steps of: for each dye trace for a ZMW, the invention retrieves pulse start and end times (Step K1); these times are combined to determine a plurality of pulses in the pre-extraction captured data (Step K2); optionally, for each pulse, determine proximate background correction values from temporally close captured pixel values that are not within a pulse (Step K3); optionally, for each pulse, examine multi-component traces to avoid false pulse combinations due to dye cross-talk (Step K4); for each pulse, temporally combine captured pixel values into a temporally averaged pulse frame (Step K5); for each pulse, compare flux values to a plurality of dye spectral templates to determine a best match, optionally using proximate background correction values (Step K6); store or output the best match as the dye classification for a significant pulse (Step K7); optionally store or output a match probability for a significant pulse, optionally using proximate background correction values (Step K8); optionally store or output alternative less-probable classifications and corresponding match probabilities for a significant pulse (Step K9); optionally store or output one or more additional pulse metrics, including inter-pulse metrics for possible use in base calling) (Step K10).

A number of comparative methods may be used to generate a comparative metric for this process. For example, in preferred aspects, a χ² test is used to establish the goodness of fit of the comparison. In a particular example, for an extracted pulse spectrum (Sᵢ), the amplitude (A) of the fit of an individual dye spectral shape; as measured from the pure dye calibration spectrum, Pᵢ, is the only variable to solve and will have a χ² value of:

$${χ}^{2} = {\sum }_{i} \frac{{( {S}_{i} - {AP}_{i} )}^{2}}{{V}_{i}}$$

The probability that the pure dye spectrum fits with the extracted spectrum is then derived from the χ² probability distribution (with a number of degrees of freedom for the number of data points used, υ). The classification of a given pulse spectrum is then identified based upon calculating values for each of the four different dyes. The lowest χ² value (and the highest probability fit), assigns the pulse to that particular dye spectrum, and the pulse is called as corresponding to that dye.

Again, other techniques may be employed in classifying a pulse to a particular spectrum, including for example, measuring correlation coefficients for each of the 4 possible dyes for the spectrum, with the highest correlation providing the indication to which base or dye the pulse will be classified.

In addition to comparison of the pulse spectra to the calibration spectra, a number of other pulse metrics may be employed in classifying a pulse as correlating to a given dye/nucleotide. In particular, in addition to the spectral properties associated with a given dye, signals associated with incorporation of a given dye labeled nucleotide typically have a number of other characteristics that can be used in further confirming a given pulse classification. For example, and as alluded to above, different dye labeled nucleotides may have different characteristics such as pulse arrival time (following a prior pulse), pulse width, signal intensity or integrated counts (also referred to as pulse area), signal to noise ratio, power to noise ratio, pulse to diffusion ratio (ratio of pulse signal to the diffusion background signal in each ZMW), spectral fit (e.g., using a minimum χ² test, or the like), spectrum centroid, correlation coefficient against a pulse's classified dye, time interval to end of preceding pulse, time interval to the ensuing pulse, pulse shape, polarization of the pulse, and the like.

In particularly preferred aspects, a plurality of these various pulse metrics are used in addition to the spectral comparison, in classifying a pulse to a given dye, with particularly preferred processes comparing two, three, five, 10 or more different pulse metrics in classifying a pulse to a particular dye/nucleotide.

### Optional Additional Trace Extraction to Avoid Conflation

As discussed herein, extraction from spectra to multiple spectral traces is may be performed according to an algorithm that maximizes the sensitivity to individual dyes in each trace. As a result of this and of the fact that selected spectral dyes may have substantial overlap, in certain situations this approach will result in single incorporation pulse being detected in two traces.

However, in some cases this may cause a merging, of pulses that should be associated with two differently classified incorporation events. To address, in specific embodiments of the invention, a secondary trace extraction is performed that attempts to deconvolve spectra. This secondary trace extraction is then used to confirm that start and end times of pulses represent a pulse in one spectral color and not in two overlapping colors.

Consensus Generation And Sequence Alignment Using Statistical Models And Pulse Features Background

Various techniques for automated “smart” base calling of Electrophoretic DNA sequencing data have been discussed. Electrophoretic DNA sequencing often involves trace data from four different dyes that are used to label four bases. PHRED is a base-calling program for automated sequencer traces that outputs at each base generally one of five base identifiers (A C T G and N for not identifiable) and often a quality score for each base. In PHRED processing of DNA traces, predicted peak locations in terms of migration times are determined, observed peaks are identified in the trace and are matched to predicted peak locations, sometimes omitting some peaks and splitting. Unmatched observed peaks may be checked for any peak that appears to represent a base but could not be assigned to a predicted peak in the third phase and if found, the corresponding base is inserted into the read sequence. Peaks in a PHRED analysis may be difficult to distinguish in regions where the peaks are not well resolved, noisy, or displaced (as in compressions). The PHRED algorithm typically assigns quality values to the bases, and writes the base calls and quality values to output files. PHRED can evaluate the trace surrounding each called base using four or five quality value parameters to quantify the trace quality. PHRED can use dye chemistry parameter data to do such tasks as identifying loop/stem sequence motifs that tend to result in CC and GG merged peak compressions. PHRAP is a sequence assembly program often used together with PHRED. PHRAP uses PHRED quality scores to determine highly accurate consensus sequences and to estimate the quality of the consensus sequences. PHRAP also uses PHRED quality scores to estimate whether discrepancies between two overlapping sequences are more likely to arise from random errors, or from different copies of a repeated sequence. Various expert analysis and similar systems have been proposed for analyzing such data, See, for example, U.S. Pat. No. 6,236,944, Expert system for analysis of DNA sequencing electropherograms. The use of statistical models, such as hidden Markov models (HMMs), for DNA sequencing has be discussed by several authors (See, e.g., Petros Boufounos, Sameh El-Difrawy, Dan Ehrlich, HIDDEN MARKOV MODELS FOR DNA SEQUENCING, Journal of the Franklin Institute, Volume 341, Issues 1-2, January-March 2004, Pages 23-36 Genomics, Signal Processing, and Statistics. HMMs have been discussed as an approach to DNA basecalling, using techniques such as modeling state emission densities using Artificial Neural Networks, and a modified Baum-Welch re-estimation procedure to perform training. Consensus sequences have been proposed to label training data to minimizing the need for hand-labeling.

In further specific embodiments, software methods of the present invention include techniques for generating consensus DNA sequence information of high accuracy from a collection of less accurate reads generated by a real-time sequencing by incorporation system. In specific embodiments, two features of data typical of some such systems that motivate these techniques are: (1) the errors in the raw data are mostly insertions or deletions of base symbols from the correct sequence, rather than ‘mismatches’ or misidentified bases; (2) a relatively large number (e.g., 1000 or more) of data points are collected in real time for each base symbol in the raw read.

As described above, a signal intensity and signal spectrum is measured through time. This results in a large collection of data features associated with each base in the raw read sequence. The time series data are summarized by finding regions of high signal intensity ‘pulses’, and measuring a series of features of those pulses, such as their duration, average intensity, average spectrum, time until the following pulse, and best reference spectra match. Observable pulses are generated when nucleotides are productively incorporated by the polymerase (‘incorporation pulses’), as well as by interfering processes (such as incorrect bases that stick temporarily but are not incorporated or correct bases that become illuminated temporarily, but are not fully incorporated, and then are incorporated and produce a second pulse (branching)) that introduce errors into the observed sequence. (Pulses that are entirely due to random noise may also be detected and are attempted to be identified as described above). The statistical nature of the process that generates the pulses results in wide, but measurable distributions of pulse features. Processes that generate spurious pulses generate pulses with different distributions of pulse features, although the distributions between spurious pulses and incorporation pulses will overlap.

Thus, in specific embodiments, a predictive HMM observation distribution model, is extended to not only identity of the called base, but also the features of the associated pulse. In this method each class of microscopic event (true incorporations as well as interfering events) generates pulses with different but overlapping probability distributions in the space of pulse features. The distribution over pulse feature space for each pulse type is learned from experimental data and used to generate an approximate observation distribution via density estimation techniques. In a final sequence alignment step, a most likely template (sequence) is discovered by constructing a series of trial models that maximize the likelihood of the observed data under the model, via an expectation maximization procedure.

The following example describes this algorithmically. Let bᵢⱼ(O) represent the probability distribution of observations received when transitioning from state i to state j of the HMM. In typical alignment applications, the alphabet of observations that it is possible to observe is limited to {A,G,C,T}. That is, each pulse observed is summarized only by its base identity. When combining multiple reads of the same DNA into a single consensus read, it is necessary to resolve the ambiguity that exists between reads. For example, in a base detection from two sources as follows:

### AGCG

### AGCG

A probability model according to specific embodiments of the invention must decide among a number of competing hypotheses about the true template. For example, in attempting to decide between a T and an A at the highlighted position the model asks which event is more likely, that a T base generates an emission that is called as an A, or that an A base is called as a T. While a standard alignment approach of choosing the template that maximizes the likelihood still applies, in the present invention the bᵢⱼ(O) that models the probability of an observation is a function not solely of the base identity, but is also extended to return a measure of the probability of observing a pulse and various of its associated features on that transition. In this example, if the T pulse has stored or associated with it observed features indicating it was a higher intensity, longer pulse (and therefore less likely to be misclassified), while the A pulse was weaker and briefer, these features would be included in the probability model with other alignment probabilities to determine whether T or A was more probable. Other features being equal, the probability of having misclassified the bright T pulse being generated from an A template location would be much smaller than the probability of the weak brief A pulse being generated from a T base, therefore the model would call T as the consensus in that position. Because the data analyzed during the consensus alignment phase includes a number of different physical parameters of identified pulses and overall reaction parameters, rather than just a single quality score, many different characteristics of a real-time incorporation sequencing reaction can be used in the predictive model. The predictive model can thus be trained to account for the probability that a detected pulse was due to a branch or a stick of a labeled nucleotide analog, probabilities of which will vary for different bases, as well as account for overall reaction quality features such as overall noise detected at a reaction location or overall confidence of spectral classifications at a reaction location.

In a particular example embodiment, each state of an example HMM models a location along the template DNA strand where the synthesizing polymerase will reside between incorporation events. Two classes of transitions that can occur from this state are (1) a “move” transition where the polymerase incorporates a base and proceeds one position along the template, with a probability denoted by and a_{i,j+} and (2) a “stay” transition where the polymerase binds a nucleotide, but unbinds before the incorporation event (a “branch”) or a labeled nucleotide “sticks” transiently to the surface of the ZMW, inside the illumination region, and the polymerase does not move along the template, with probability given by a_{i,j}. A branch generally emits the symbol corresponding to the current template location while a stick generates a random symbol. The probability of branching and sticking are modeled as a function of the observation symbols (A C T G and null), and optionally modeled as a function of symbols for pulse metrics, such as intensity, duration, forward interval, subsequent interval, etc.

There are a variety of potential methods for generating the b_{i,j}(O) probability distribution for a multi-dimensional space of pulse parameters. Given the various pulse parameters and reaction parameters that may be calculated and stored as described herein, one presently preferred approach is to learn the distribution from empirical data acquired from known templates. By aligning the acquired pulse stream to the known template, pulses from a variety of classes can be used to generate empirical parameter distributions.

One method of scoring such a model during training is determining parameters that result in a maximum alignment length as is understood in the art.

### OTHER EMBODIMENTS

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, etc.

Although the present invention has been described in terms of various specific embodiments, it is not intended that the invention be limited to these embodiments. Modification within the spirit of the invention will be apparent to those skilled in the art. In addition, various different actions can be used to effect a request for sequence data.

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

We claim:

1. A method for measuring the optical emission from an array of sources from an analytical reaction comprising:
providing an array comprising a transparent substrate having an opaque cladding layer on its top surface having an array of nanoscale apertures extending through the cladding layer to the top surface of the transparent substrate;
contacting the array with an analytical sample comprising one or more fluorescent labels;
positioning the array within an optical system of an analytical instrument;
illuminating the array from below with a excitation light such that fluorescent light emitted from each of the apertures is imaged within a region of X by Y pixels on each of D detectors;
measuring the relative intensity at each of the pixels on each of the regions of X by Y pixels at each of the D detectors;
using the relative intensities detected at each of the X by Y pixels to define a software mask having a weighting factor for each of the X by Y pixels;
sending signals from the D detectors to a computer for processing the signals; and
using the software mask to treat signals sent from the D detectors, thereby improving the signal to noise of the measured emitted fluorescent light from the apertures over the signal to noise without the software mask.

2. The method of claim 1 wherein the software mask is defined by determining a centroid for each feature and determining a point spread function (PSF) for each feature.

3. The method of claim 1 wherein the software mask is defined by determining a centroid for each feature and applying a pre-determined point spread function (PSF) for each feature.

4. The method of claim 1 wherein the weighting factor for each of the pixels includes a noise component.

5. The method of claim 1 wherein the weighting factor comprises an inverse variance value for each pixel.

6. The method of claim 5 wherein the inverse variance value for each pixel is determined during the analytical reaction.

7. The method of claim 1 wherein the fluorescent light used to define the software mask comprises background fluorescence.

8. The method of claim 1 wherein the fluorescent light used to define the software mask comprises signals corresponding to the analytical reaction.

9. The method of claim 1 wherein the fluorescent light used to define the software mask comprises signals corresponding to the analytical reaction and background fluorescence.

10. The method of claim 1 wherein the array comprises between 10,000 and 5 million nanoscale apertures.

11. The method of claim 1 wherein the D is 1, 2, 3, 4, 5, or 6.

12. The method of claim 11 wherein D is 4.

13. The method of claim 1 wherein the light imaged on each of the D detectors represents a different portion of the optical spectrum.

14. The method of claim 1 wherein, the analytical sample comprises D fluorescent labels, and the light imaged on each of the D detectors represents a portion of the spectrum corresponding to one of the D fluorescent labels.

15. The method of claim 1 wherein the analytical reaction comprises the measurement of binding or association.

16. The method of claim 15 wherein one member of a binding pair is immobilized within the apertures, another member of the binding pair is in solution, and the emitted light is used to measure the binding or association.

17. The method of claim 16 wherein FRET and/or fluorescence quenching is used to measure the binding or association.

18.-24. (canceled)

25. The method of claim 1 wherein the software mask is comprised of a centroid corresponding to each aperture and a set of weights derived from a PSF describing the relative pixel weighting relative to the centroid for that aperture.

26. The method of claim 25 wherein a PSF for each of the apertures is measured during the measuring step.

27. The method of claim 25 wherein a PSF for each of the apertures is determined prior to the measuring step.

28. A sequencing method comprising:
providing an array comprising a transparent substrate having an opaque cladding layer on its top surface having an array of nanoscale apertures extending through the cladding layer to the top surface of the transparent substrate;
contacting the array with a sequencing reaction, mixture comprising D fluorescently labeled nucleotide analogs and a polymerase complex comprising a polymerase, a primer and a template nucleic acid;
positioning the array within an optical system of an analytical instrument;
initiating the sequencing reaction;
illuminating the array from below with a excitation light such that fluorescent light emitted from each of the apertures is imaged onto a region of X by Y pixels on each of D detectors;
measuring the relative intensity at each of the X by Y pixels while the sequencing reaction is occurring;
using the relative intensities detected at each of the X by Y pixels to define a software mask having a weighting factor for each of the pixels;
sending signals from the D detectors to a computer for processing the signals;
using the software mask to treat signals coming from the D detectors, thereby improving the signal to noise of the measured emitted fluorescent light from the apertures over when the software mask is not used.

29. The method of claim 28 wherein the software mask is defined by determining a centroid for each feature and determining a point spread function (PSF) for each feature.

30. The method of claim 28 wherein the software mask is defined by determining a centroid for each feature and applying a pre-determined point spread function (PSF) for each feature.

31.-47. (canceled)

48. A method for measuring the optical emission from an array of sources from an analytical reaction comprising:
providing an array comprising a transparent substrate having an opaque cladding layer on its top surface having an array of nanoscale apertures extending through the cladding layer to the top surface of the transparent substrate;
positioning the array within an optical system of an analytical instrument;
illuminating the array in transmission mode by passing light through the apertures from the top;
imaging the transmitted light through each of the apertures onto a region of X by Y pixels on each of D detectors;
measuring the relative intensity at each of the X by Y pixels;
using the relative intensities detected at each of the X by Y pixels to define a software mask having a weighting factor for each of the pixels;
performing an analytical reaction in at least some of the nanoscale apertures;
illuminating the array from below with a excitation light such that fluorescent light is emitted from the apertures, detected at the detectors, and used to characterize the analytical reaction; and
using the software mask to treat signals from the detector to improve the signal to noise of the measured emitted fluorescent light at each of the D detectors over that without the software mask.

49.-53. (canceled)

54. A method of concurrently measuring D spectrally different fluorescent emission signals in an analytical instrument where D is greater than 1 comprising:
i. providing a first array comprising a transparent substrate having an opaque cladding layer on its top surface having an array of nanoscale apertures extending through the cladding layer to the top surface of the transparent substrate;
ii. contacting a first array with a liquid sample comprising a one of D fluorescent labels;
iii. positioning the array within an optical system of an analytical instrument;
iv. illuminating the array from below with a excitation light such that fluorescent light emitted from each of the apertures is imaged within a region of X by Y pixels on each of D detectors, wherein each of the D detectors has a different spectral sensitivity, each representing a spectral channel;
v. repeating steps ii-iv for each of D fluorescent labels, thereby obtaining the relative intensity for each of the D dyes on each region of X by Y pixels on each of D detectors;
vi. using the relative intensity data to produce a matrix of relative intensities for each region of X by Y pixels on each of the D detectors.
vii. positioning a second array within the optical system;
viii. contacting the second array with an analytical sample comprising each of the D fluorescent labels;
ix. illuminating the second array from below with a excitation light such that fluorescent light emitted from the analytical sample from at least some of the apertures is imaged onto the regions of X by Y pixels on the D detectors; and
x. using the matrix produced in step vi to identify one or more of the D fluorescent labels in the analytical sample, thereby providing information about the analytical sample.

55.-61. (canceled)

62. An instrument for single-nucleic acid sequencing comprising:
an optical system comprising D detectors, each detector sensitive to a different portion of the light spectrum each representing a spectral channel;
an array positioned in the optical system comprising a transparent substrate having an opaque cladding layer on its top surface having an array of nanoscale apertures extending through the cladding layer to the top surface of the transparent substrate;
a sequencing reaction mixture in contact with the array comprising D fluorescently labeled analogs and a polymerase complex comprising a polymerase, a primer and a template nucleic acid;
an illumination system configured to illuminate the array from above with transmission light and from below with a excitation light such that either transmitted light or fluorescent emitted light from each of the apertures can be imaged within a region of X by Y pixels on each of the D detectors; and
a computer system configured to use the relative intensities detected at each of the X by Y pixels to define a software mask having a weighting factor for each of the pixels; and configured to use the software mask to treat signals coming from the D detectors to improve the signal to noise of the measured emitted fluorescent light at each of the D detectors.

63.-72. (canceled)
